(19) United States
(12) Patent Application Publication
(10) Pub. No.: US 2025/0102710 A1
(43) Pub. Date: Mar. 27, 2025

(54) OPTICAL FUNCTIONAL THIN FILM

(71) Applicant: NINGBO EXCITON TECHNOLOGY CO., LTD., Ningbo (CN)

(72) Inventors: Kai MIAO, Ningbo (CN); Ruixin LI, Ningbo (CN); Lingjie WANG, Ningbo (CN); Gang LI, Ningbo (CN); Haijiang TANG, Ningbo (CN); Yan ZHANG, Ningbo (CN)

(73) Assignee: NINGBO EXCITON TECHNOLOGY CO., LTD., Ningbo (CN)

(21) Appl. No.: 18/724,923

(22) PCT Filed: Dec. 13, 2022
(86) PCT No.: PCT/CN2022/138834

§ 371 Date: Jun. 27, 2024

(30) Foreign Application Priority Data
Dec. 29, 2021 (CN) 202111635631.7

(51) Int. Cl. G02B 5/02; G02F 1/13; G02F 1/1335

(52) U.S. Cl. CPC G02B 5/0221; G02F 1/1323; G02F 1/133562

(57) ABSTRACT

An optical functional thin film, sequentially comprising a release layer (05), a bonding layer (04), a substrate layer (01), an optical structure layer (02) and a filling layer (03). The optical structure layer (02) refracts light to increase a viewing angle. A surface of the filling layer (03) is provided with a fluctuating structure. The optical functional thin film can be used for being externally attached to the outer side of a screen of a liquid crystal display device, and is used for alleviating the defect of horizontal or vertical brightness viewing angles of existing liquid crystal display devices being narrow (small); and the fluctuation of a color cast value viewing angle curve is relatively low, such that the subjective feeling during the use of the liquid crystal display device to which the optical functional thin film is attached is better.

### TECHNICAL FIELD

The present invention belongs to the field of an optical thin film technology, and relates to an optical functional thin film.

### BACKGROUND TECHNOLOGY

With the continuous updates and iterations of digital TV technology, LCD displays have gradually become the mainstream of digital TV terminal display devices. Due to the limitation of physical characteristics of the liquid crystals and physical structures of the display devices, the liquid crystal displays have a relatively narrow (small) viewing angle, which can be divided into brightness viewing angle and color deviation viewing angle. It is the maximum viewing angle at which the LCD displays experience “picture distortion”, dividing into a horizontal viewing angle and a vertical viewing angle. As the viewing angle increases, the brightness and color deviation presented on the screen gradually exceed the limit value, making it possible for the human eye to detect abnormalities. This phenomenon is called “picture distortion”.

In recent years, the emergence of new intelligent teaching environments such as seminar based smart classrooms has further expanded the application scenarios of LCD devices, not only limited to home entertainment. At the same time, the increase in the number of viewers and viewing angles puts higher demands on the viewing angle of LCD display devices. According to GB40070-2021 “Hygienic requirements for myopia prevention and control in educational supplies for children and adolescents”, the brightness level viewing angle of LCD display devices must exceed 120°. Therefore, improving the brightness level viewing angle of LCD display devices is still an important issue in the field of LCD display.

### SUMMARY OF THE INVENTION

In order to solve problems of small brightness level viewing angle of the existing LCD displays, the present invention provides an optical functional thin film, the optical functional thin film can be applied externally on the outside of the LCD display device screen, to improve deficiencies of the narrow (small) horizontal or vertical brightness viewing angle of existing LCD display devices.

To solve the above technical problems, the present invention adopts the following technical solution.

The present invention provides an optical functional thin film, which successively comprises a release layer, a bonding layer (serving as a bonding layer), a substrate layer, an optical structure layer, and a filling layer.

There is a refractive index difference between the optical structure layer and the filling layer, which causes refraction of light and increases the viewing angle.

Furthermore, the optical functional thin film sequentially comprises a release layer, a bonding layer, a substrate layer, and an optical structure layer, and filling layer.

Furthermore, the surface of the filling layer has a fluctuating structure.

Furthermore, the refractive index N1 of the optical structure layer is greater than the refractive index N2 of the filling layer.

Furthermore, the refractive index N1 of the optical structure layer is L62, and the refractive index N2 of the filling layer is 1.43-1.50.

The present invention provides an optical functional thin film (as shown in FIG. 1A), consisting of a first substrate layer 01, a second optical structure layer 02 (with the refractive index of N1), a third filling layer 03 (with the refractive index of N2), a fourth bonding layer 04, and a fifth release layer 05. It can be used for adhering externally on the outside of LCD display devices to improve deficiencies of the narrow (small) horizontal or vertical brightness viewing angle of existing LCD display devices.

After adhering the optical functional thin film provided by the present invention, a new maximum value of color deviation value appears at a specific viewing angle, in the color deviation value viewing angle curve of the liquid crystal display device. When switching from a front viewing angle to a aide viewing angle, the human eyes can perceive a abrupt change in color deviation near the corresponding maximum value, which greatly affects the subjective perception of watching LCD devices of human eyes. The severity of the mutation process is influenced by the difference between the maximum color deviation value and the deviation value of the adjacent next visual character bias.

On the other hand, in order to solve the above-mentioned technical problems, the present invention adopts the following technical solution.

The present invention provides another optical functional thin film (as shown in FIG. 1B), consisting of a first substrate layer 01, a second optical structure layer 02 (with the refractive index of N1), a third filling layer 03 (with the refractive index of N2), a fourth bonding layer 04, and a fifth release layer 05. Furthermore, there is a certain undulating structure on the outside of the third layer filling layer 03. When it is applied externally to the outside of the LCD display device screen, it can improve deficiencies of the narrow horizontal or vertical brightness angle and the narrow color deviation viewing angle of existing LCD display devices, meanwhile further enhance the uniformity of the brightness and color deviation angle curve, reduce the fluctuation degree of the process of abrupt changes in brightness and color deviation values upon the angle changes, and enhance the subjective feeling of the LCD display device after adhering this optical functional thin film.

Furthermore, the substrate layer in the present invention uses polyethylene terephthalate (PET), or other substrates that can be used as load-bearing materials (such as SRF, polycarbonate (PC), and triacetate fiber ester (TAC), etc., with unlimited thickness.

The refractive indexes of the optical structure layer and the filling layer have a certain difference, wherein the refractive index of the optical structure layer is greater than that of the filling layer. In the present invention, the light that are near collimation incidence will first undergo a total reflection at the trapezoidal slope, and then exit after undergoing a refraction at the refractive index difference interface of the trapezoid upper bottom, the exited light deviates from the direction of the incident light, which helps to improve the brightness visibility angle and color deviation viewing angle of the liquid crystal display device.

Furthermore, the refractive index of the UV curable-molding acrylic resin is the liquid refractive index at 25° C. The UV curable-molding acrylic resin is abbreviated as an UV curing acrylic resin.

Generally, the greater the difference in refractive index between the optical structure layer and the filling layer, the greater the angle of light deflection, the more significant the effect of improving the viewing angle of a LCD device.

Furthermore, the surface of the optical structure layer has several microstructures arranged at intervals in direction one and infinitely extending the same in direction two, and the cross-section of the microstructures is an isosceles trapezoidal structure (FIG. 2A and FIG. 2B). Furthermore, the surface connecting the optical structure layer with the filling layer has several microstructures arranged at intervals in direction one and infinitely extending the same direction two, the cross-section of the microstructure is an isosceles trapezoidal structure (FIG. 2A and FIG. 2B). The microstructures whose cross-section is an isosceles trapezoidal structure are abbreviated as isosceles trapezoidal microstructures.

Furthermore, grooves are formed between adjacent isosceles trapezoidal microstructures, and the cross-section of the grooves is an inverted trapezoidal structure.

Furthermore, improving the horizontal or vertical viewing angle of liquid crystal display devices depends on the orientation of the trapezoidal structure. When the trapezoidal structure is vertically oriented, this optical functional thin film can enhance the horizontal viewing angle of liquid crystal display devices. When the trapezoidal structure is horizontally oriented, it can enhance the vertical viewing angle of liquid crystal display devices. Unless otherwise specified, the viewing angles mentioned in all embodiments and examples of the present invention are horizontally viewable.

The present invention also provides a sample preparation method for an optical functional thin film (FIG. 1A and Figure (B)), comprising the following steps:
1. Engrave and shape on metal nickel plates through mechanical processing, whereby obtaining a metal mold containing the trapezoid-structure;
2. Apply a sufficient amount of UV curable curable-molding acrylic resin (with the refractive index of N1) onto the metal mold, and then cover with A4 sized PET substrate on the acrylic resin, apply uniform pressure on the upper of the PET using a rubber roller to ensure that the acrylic resin evenly fills layers of the metal nickel plate and the PET;
3. Place the above samples under certain UV curing conditions for UV curing, remove the metal nickel plate, and flip the mold to obtain a semi-finished product a with a trapezoidal structure on one side;
4. Continue to fill the side of the optical structure layer of the semi-finished product a with a third layer of UV curable acrylic resin as the filling layer (with a refractive index of (2), so that the filling layer is uniformly filled with grooves in the trapezoidal structure layer and covered with a layer of transparent or frosted release film, with the frosted side facing the filling layer side, whereby obtaining a transparent or certain haze of semi-finished product b after photocuring;
5. Continue to apply a layer of OCA tape on one side of the substrate layer of the semi-finished product b, whereby obtaining an optical functional thin film (FIG. 1A and FIG. 1B);
6. Apply the finished product with a bonding layer to the outside of the LCD display screen (near the human side) for optical performance evaluation.

The microstructure parameters in the optical structure layer (as shown in FIG. 2A) are designed as follows: period p: 16.3 μm, length of upper base edge a=6 μm, depth h: 9.90-12.05 μm, and the lower base angle θ-79.0°. The first characteristic value t is defined as the proportion of width of the inclined edge of the isosceles trapezoid of the microstructure in a single period projecting onto the lower bottom, which occupies a single period, i.e. t=2hcotθ/p. Furthermore, the refractive index N1 of the optical structure layer is 1.62, and the refractive index N2 of the filling layer is 1.50.

Furthermore, the surface of the filling layer has a fluctuating structure. Furthermore, the haze of the filling layer is 25%.

Furthermore, the first characteristic value t is 23.61%-28.74%. The aforementioned technical solution includes embodiments 7-14.

Furthermore, the refractive index N1 of the optical structure layer is 1.62, the refractive index N2 of the filling layer is 1.50, and the first characteristic value t is 23.61-24.50% or t is 27.45-27.59%. The aforementioned technical solution comprises embodiments 9-10 and embodiments 13-14.

Compared with the existing technology, the optical function thin film provided by the present invention can be externally applied on the outside of the LCD display device screen to increase the viewing angle, the LCD display device after adhering has an uniformly distributed brightness viewing angle curve and color deviation viewing angle curve. Furthermore, the curve fluctuation with lower color deviation angle curve makes the subjective perception of the liquid crystal display devices better after adhering the optical function thin film.

### FIGURES OF THE DESCRIPTION

FIG. 1A is a schematic structural diagram of an optical functional thin film provided by the present invention;

FIG. 1B is a schematic structural diagram of an optical functional thin film provided by the present invention;

FIG. 2A is a cross-sectional schematic structural diagram of the optical structure layer of the optical functional thin film provided by the present invention;

FIG. 2B is a top view structural schematic diagram of the optical structure layer of the optical functional thin film provided by the present invention;

FIG. 3A shows the brightness viewing angle curve of the original LCD display device and the brightness viewing angle curve of the LCD display device after adhering the optical functional thin film provided in Embodiment 1 (normalized);

FIG. 3B shows the color deviation angle curve of the original LCD display device and the color deviation angle curve of the LCD display device after adhering to the optical functional thin film provided in Embodiment 1;

FIG. 4A shows the brightness angle curve of the original LCD display device and the brightness angle curve of the LCD display device after adhering the optical function thin film provided by example 1 (normalized);

FIG. 4B shows the color deviation angle curve of the original LCD display device and the color deviation angle curve of the LCD display device after adhering the optical function thin film provided by example 1;

FIG. 5A shows the brightness viewing angle curve of the original LCD display device and the brightness viewing angle curve of the LCD display device after adhering the optical function thin film provided in embodiment 2 (normalized);

FIG. 5B shows the color deviation angle curve of the original LCD display device and the color deviation angle curve of the LCD display device after adhering the optical functional thin film provided in embodiment 2;

FIG. 6A shows the brightness viewing angle curve of the original LCD display device and the brightness viewing angle curve of the LCD display device after adhering the optical functional thin film provided in embodiment 3 (normalized);

FIG. 6B shows the color deviation angle curve of the original LCD display device and the color deviation angle curve of the LCD display device after adhering the optical functional thin film provided in embodiment 3;

FIG. 7A shows the color deviation angle curve of the original LCD display device and the color deviation angle curve of the LCD display device after adhering to the optical functional thin film provided in embodiment 4 (normalized);

FIG. 7B shows the brightness viewing angle curve of the original LCD display device and the color deviation angle curve of the LCD display device after adhering the optical functional thin film provided in embodiment 4;

FIG. 8A shows the brightness viewing angle curve of the original LCD display device and the brightness viewing angle curve of the LCD display device after adhering the optical functional thin film provided in embodiment 5 (normalized);

FIG. 8B shows the color deviation angle curve of the original LCD display device and the color deviation angle curve of the LCD display device after adhering the optical functional thin film provided in embodiment 5;

FIG. 9A shows the brightness viewing angle curve of the original LCD display device and the normalized brightness viewing angle curve of the LCD display device after adhering the optical functional thin film provided in embodiments 1 and 6 (normalized);

FIG. 9B shows the color deviation angle curve of the original LCD display device and the color deviation angle curve of the LCD display device after adhering the optical functional thin film provided in embodiments 1 and 6;

FIG. 10A shows the brightness viewing angle curve of the original LCD display device and the normalized brightness viewing angle curve of the LCD display device after adhering the optical functional thin film provided in embodiment 7 (normalized);

FIG. 10B shows the color deviation angle curve of the original LCD display device and the color deviation angle curve of the LCD display device after adhering the optical functional thin film provided in embodiment 7;

FIG. 11A shows the brightness viewing angle curve of the original LCD display device and the brightness viewing angle curve of the LCD display device after adhering the optical functional thin film provided in embodiment 8 (normalized);

FIG. 11B shows the color deviation angle curve of the original LCD display device and the color deviation angle curve of the LCD display device after adhering the optical functional thin film provided in embodiment 8;

FIG. 12A shows the brightness viewing angle curve of the original LCD display device and the brightness viewing angle curve of the LCD display device after adhering the optical functional thin film provided in embodiment 9 (normalized);

FIG. 12B shows the color deviation angle curve of the original LCD display device and the color deviation angle curve of the LCD display device after adhering the optical functional thin film provided in embodiment 9;

FIG. 13A shows the brightness viewing angle curve of the original LCD display device and the brightness viewing angle curve of the LCD display device after adhering the optical functional thin film provided in embodiment 10 (normalized);

FIG. 13B shows the color deviation angle curve of the original LCD display device and the color deviation angle curve of the LCD display device after adhering the optical functional thin film provided in embodiment 10;

FIG. 14A shows the brightness viewing angle curve of the original LCD display device and the brightness viewing angle curve of the LCD display device after adhering the optical functional thin film provided in embodiment 11 (normalized);

FIG. 14B shows the color deviation angle curve of the original LCD display device and the color deviation angle curve of the LCD display device after adhering the optical functional thin film provided in embodiment 11;

FIG. 15A shows the brightness viewing angle curve of the original LCD display device and the brightness viewing angle curve of the LCD display device after adhering the optical functional thin film provided in embodiment 12 (normalized);

FIG. 15B shows the color deviation angle curve of the original LCD display device and the color deviation angle curve of the LCD display device after adhering the optical functional thin film provided in embodiment 12;

FIG. 16A shows the brightness viewing angle curve of the original LCD display device and the brightness viewing angle curve of the LCD display device after adhering the optical functional thin film provided in embodiment 13 (normalized);

FIG. 16B shows the color deviation angle curve of the original LCD display device and the color deviation angle curve of the LCD display device after adhering the optical functional thin film provided in embodiment 13;

FIG. 17A shows the brightness viewing angle curve of the original LCD display device and the brightness viewing angle curve of the LCD display device after adhering the optical functional thin film provided in embodiment 14 (normalized);

FIG. 17B shows the color deviation angle curve of the original LCD display device and the color deviation angle curve of the LCD display device after adhering the optical functional thin film provided in embodiment 14;

FIG. 18A shows the brightness viewing angle curve of the original LCD display device and the brightness viewing angle curve of the LCD display device after adhering the optical functional thin film provided by example 2 (normalized);

FIG. 18B shows the color deviation angle curve of the original LCD display device and the color deviation angle curve of the LCD display device after adhering the optical function thin film provided by example 2;

FIG. 19 is a schematic diagram of the optical path through which the light emitted from the screen passes through the optical functional thin film provided by the application.

### DESCRIPTION OF THE INVENTION

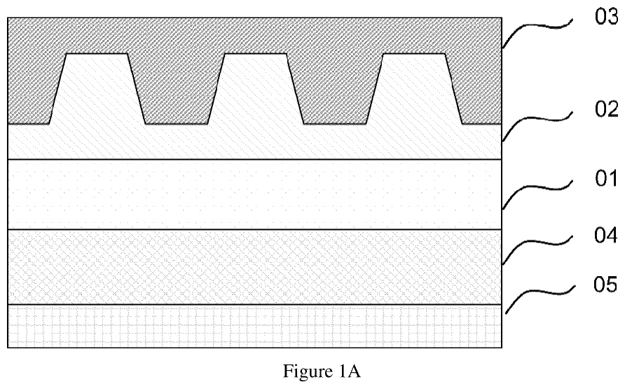

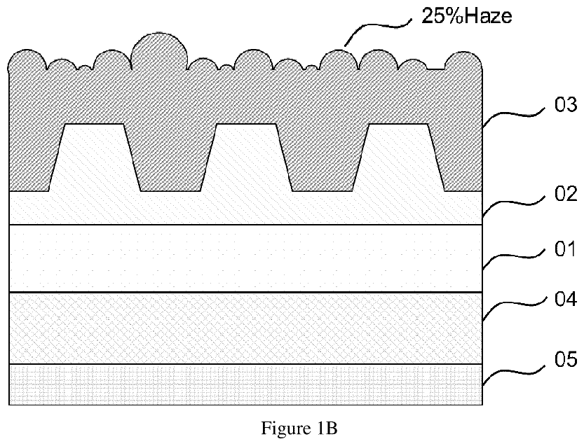

In order to facilitate a better understanding of the structure, functional features, and advantages of the present invention, the following text will provide a detailed explanation of the preferred embodiments of the present invention in conjunction with the diagram: As shown in FIG. 1, the present invention provides an optical functional thin film, the optical functional thin film sequentially comprises the fifth release layer 05, four bonding layer 04, the first substrate layer 01, the second optical structure layer 02 (with the refractive index of N1), and the third layer filling layer 03 (with the refractive index of N2). The cross-section of the surface of the second optical structure layer has trapezoidal protrusions, with inverted trapezoidal grooves between adjacent trapezoidal protrusions.

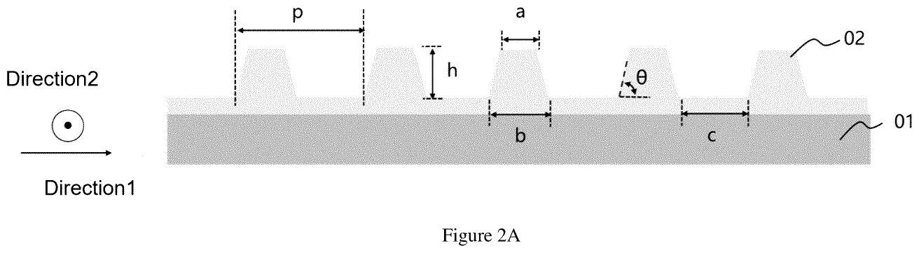

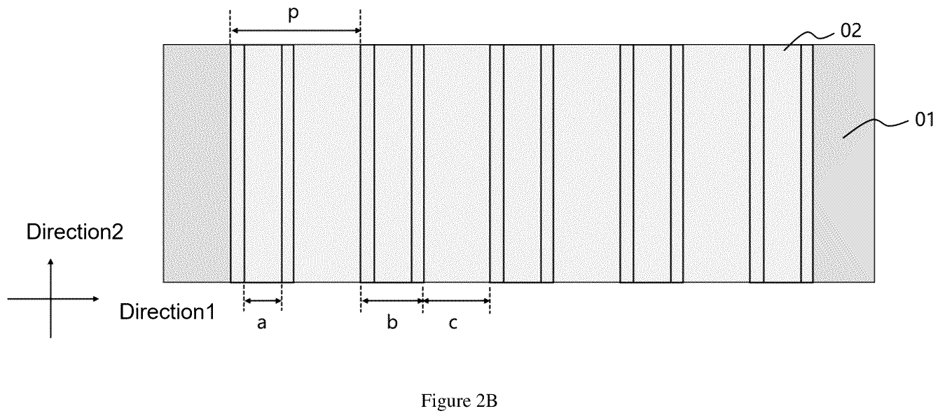

As shown in FIG. 1B, the present invention provides an optical functional thin film, which is sequentially comprises a fifth release layer 05, a fourth bonding layer 04, a first substrate layer 01, a second optical structure layer 02 (with the refractive index of N1), and a third filling layer 03 (refractive index (2), especially with a certain undulating (protrusion) structure on the filling layer 03. The cross-section of the optical structure layer 02 has isosceles trapezoidal protrusions, with inverted trapezoidal grooves between adjacent trapezoidal protrusions. As shown in FIGS. 2A and 2B, the second optical structure layer in the present invention is composed of multiple isosceles trapezoidal microstructures arranged at intervals in direction one and infinitely extending in direction two. The structural parameters are as follows: period p=16.3 μm, the upper bottom a=6.0 μm, the depth h=9.90-12.05 μm, and the lower bottom angle θ=79.0°. Define the first characteristic value is t=2hcotθ/p.

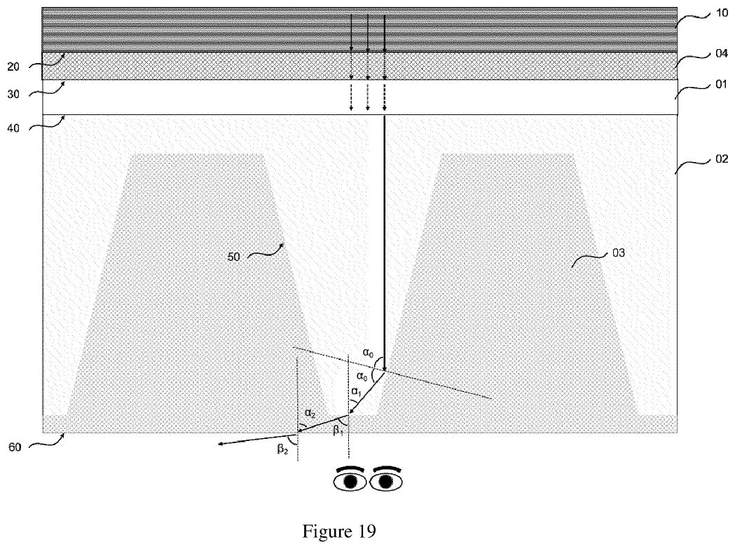

As shown in FIG. 19, the light emitted by the liquid crystal display device 10 is emitted through the bonding layer 04, the substrate layer 01, the optical structure layer 02, and the filling layer 03. The refractive index N1 of the optical structure layer is greater than the refractive index N2 of the filling layer, and the light enters the low refractive index material layer from the high refractive index material layer.

In FIG. 19, 01 represents the substrate layer, 02 represents the optical structure layer, 03 represents the filling layer, 04 represents the bonding layer, 10 represents the liquid crystal display device, 20 represents the interface 1, 30 represents the interface 2, 40 represents the interface 3, and 50 represents the interface 4; 60 represents interface 5.

The optical performance evaluation is carried out by peeling off the release layer from the optical functional thin film (the finished product) provided by the embodiments and examples, and adhering the bonding layer to the outside of the LCD display device screen (near the human side).

### The Evaluation Method for the Brightness Viewing Angle and the Color Deviation Value of the Liquid Crystal Display Devices:

### Type of the LCD Display Device: VA Type LCD Display

Model of test brightness meter model: BM-5AS, with the testing viewing angle range and interval being-80 to 80°. Each interval is 5° for the step size testing and recording the corresponding optical data.

### Test Steps:

The 100% full white field is inputted into the monitor before testing, and in order to ensure that after the measurement begins, the characteristics of the display do not change significantly over time, it is necessary to keep the monitor running under rated measurement conditions for more than 30 minutes. The brightness and color deviation of the original screen in the white field is tested and recorded using BM-5AS, and when the center brightness difference between the adjacent two tests is less than 1cd/m², the default is that the display characteristics are stabilized.

After tearing off the release film of the optical functional thin film sample to be tested, the optical functional thin film is applied under a certain pressure with a rubber roller and evenly adhere it onto the outside of the LCD display device screen to avoid visible bubbles to the naked eyes during adhesion. Subsequently, the brightness and color deviation angle curves of the liquid crystal display device adhered with the optical functional thin film are evaluated.

The left and right brightness viewing angles of the LCD display devices are defined as the viewing angles corresponding to the 1/3 center brightness, and the brightness viewing angle of the LCD display devices is the sum of the left and right brightness viewing angles. The left and right color deviation viewing values of the LCD display devices are defined as the corresponding viewing angle when Δu′v′<0.02, and the color deviation angle curve of the LCD display devices is the sum of the left and right color deviation angle curves.

The definition of the center brightness loss is: (the brightness value of the screen center of the LCD display device before adhering-the brightness value of the screen center of the LCD display device after adhering)/the brightness value of the screen center of the LCD display device before adhering multiplied by 100%.

The three key performance indicators of the optical functional thin film provided by the present invention are the center brightness loss, the brightness visibility angle (the sum of the left and right viewing angles corresponding to the 1/3 center brightness), and the color deviation angle curves (the sum of the left and right viewing angles when Δu′v′<0.02). Meanwhile, the subjective perception of the liquid crystal display devices after adhering the optical films is also very important, especially the appearance of other maximum values except for the front view angle on the brightness and the color deviation viewing angle curves, this can cause the human eyes to observe a abrupt change in brightness or color deviation during the process of the viewing angle transformation, which affects the subjective perception of the human eyes.

### Embodiment 1

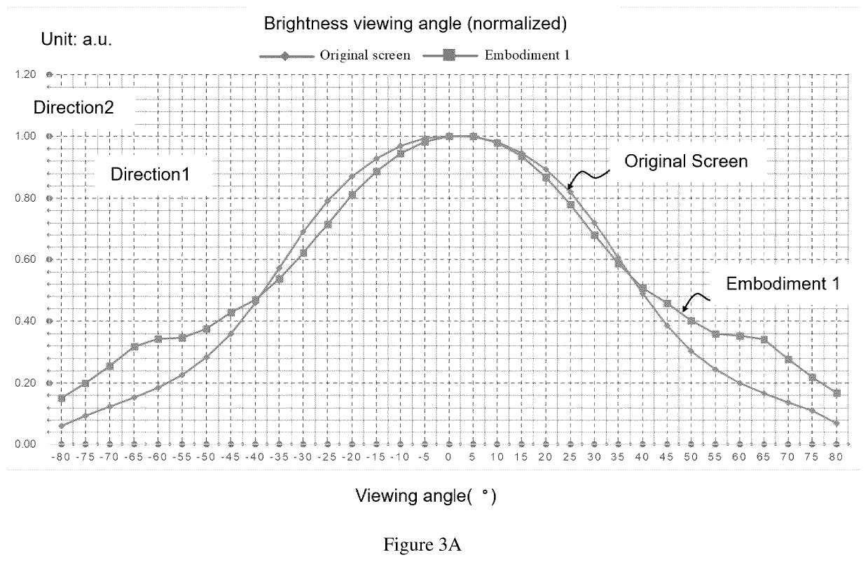

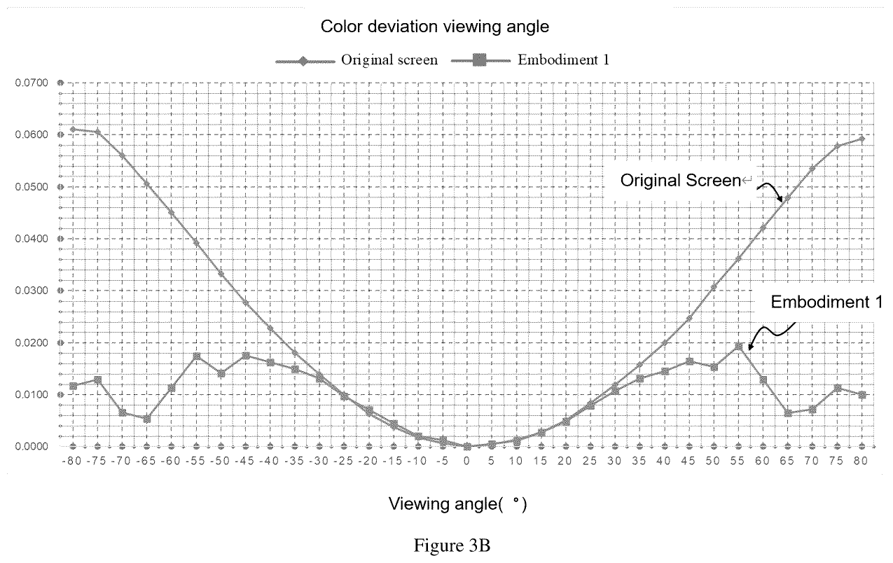

The present invention provides an optical functional thin film, which is sequentially comprises a fifth release layer 05, a fourth bonding layer 04, a first substrate layer 01, a second optical structure layer 02 (with the refractive index of N1), 25, and a third filling layer 03 (with the refractive index of N2). Wherein, the first substrate layer is 100 μm of PET, while the second and third layers are both made with a light curable molding acrylic resin with the refractive index N1 and N2 are 1.62 and 1.50, respectively. The forth layer is an OCA bonding layer (with the refractive index of 1.48, and the thickness of 30 μm). There is the fifth layer, the release layer adhering on the outside of the OCA layer. Among them, the structural parameters of the isosceles trapezoid microstructures are: period p=16.3 μm, upper bottom a=6.0 μm, depth h=12.0 μm, and lower bottom angle θ-79.0°, the first characteristic value is t=28.62%. As shown in FIGS. 3A and 3B, compared to the original screen, the LCD display device adhering the one in embodiment 1 has significantly improved brightness viewing angle and color deviation angle curves. Except for the maximum brightness value in the front view, there are no new maximum or minimum brightness values in the left and right viewing angle angles of the brightness viewing angle curve. As the viewing angle increases, the brightness assumes a trend of uniform decreasing. In the color deviation angle curve, the color deviation value uniformly increases in the range from −40 to −0° on the left viewing angle, however, there are significant fluctuations in the range from −40 and −80°. The color deviation value assumes a similar pattern of change on the right viewing angle. Although the color deviation value fluctuates greatly in the large viewing angles, the overall color deviation value is less than 0.02 within the testing intervals. As the LCD screen is shifted from the front view to the side viewing angle, the human eyes can perceive a significant change in the color deviation.

### EXAMPLE 1

According to the optical functional thin film provided in Embodiment 1, wherein,

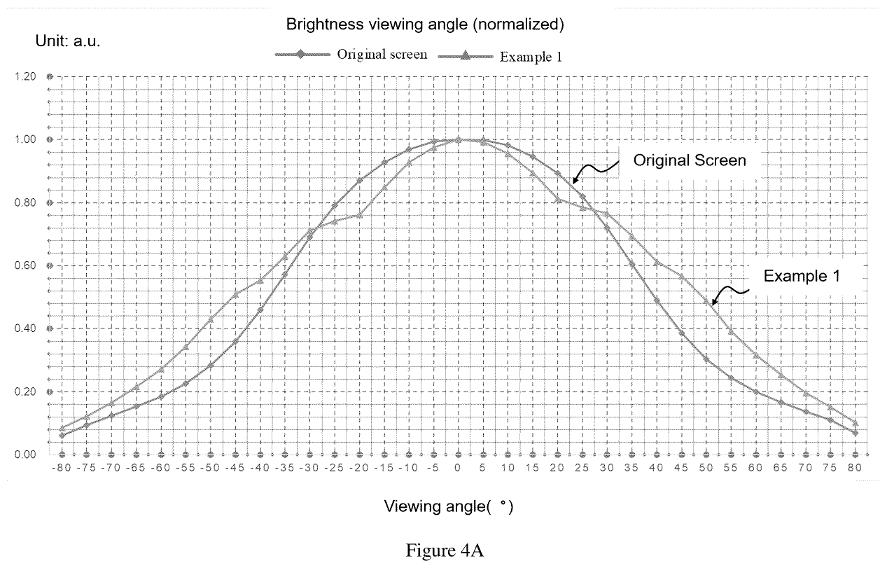

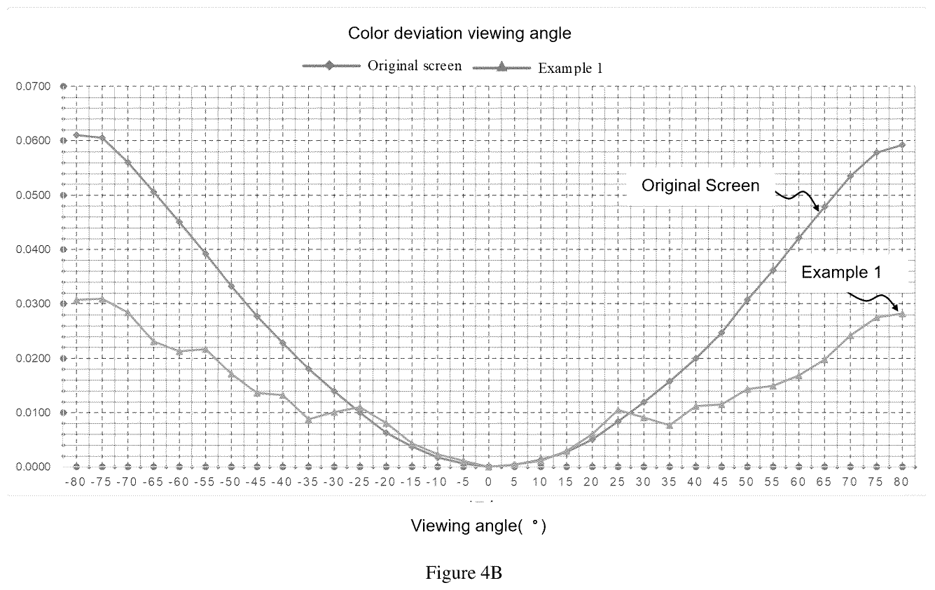

The refractive index N1 of the second layer with the refractive index N2 of the third layer is interchanged, adjusting to N1=1.50 and N2=1.62, and keeping the other designs consistent with Embodiment 1. As shown in FIGS. 4A and 4B, compared to the original screen, the LCD display device adhering example 1 assumes a significant improvement in brightness viewing angle and color deviation viewing angle. Similar to Embodiment 1, there is no new maximum brightness or minimum brightness values appearing on the brightness viewing angle curve except for the maximum brightness value in the positive view angle. As the viewing angle increases, the brightness assumes a gradually decreasing trend. Unlike the Embodiment 1, the uniformity of the curve shape of the brightness viewing angle in Example 1 is slightly decreases. In the color deviation value viewing angle curve, the overall color deviation value assumes an increasing trend, while multiple maximum and minimum values appearing in areas of the left viewing angle or right viewing angle. Taking the left viewing angle area as an example, −25°, −40°, and −55° are the maximum values corresponding to the color deviation value, and the −35° is the minimum value corresponding to the color deviation value; The color deviation value of the right viewing angle assumes a similar change of pattern. In addition, when the viewing angle is greater than −55° or the color deviation value is greater than 0.02, as the LCD screen is shifted from a front viewing angle to a side viewing angle, the human eyes can perceive a significant change in the color deviation.

TABLE 1
Brightness and color deviation visual angle data for Embodiment 1 and
Embodiment1

| | The refractive index | The refractive index | The center | The brightness | The color deviation |
|---|---|---|---|---|---|
| | of the second layer | of the third layer | brightness loss | viewing angle | value viewing angle |
| Items | N1 | N2 | (%) | (°) | (°) |
| Original screen | / | / | / | 94.8 | 77.0 |
| Embodiment 1 | 1.62 | 1.50 | 9.6 | 127.4 | 180.0 |
| Example 1 | 1.50 | 1.62 | 12.9 | 114.6 | 141.5 |

Table 1 shows the test data related to the center brightness loss, the brightness and color deviation visual angles, etc. of the LCD display device comparing to the original LCD display device, after adhering embodiment 1 and example 1. In both embodiment 1 and example 1, the brightness and the color deviation viewing angle values of the original LCD display device can be significantly improved. Compared to the loss of 12.9% in the center brightness of the LCD display device after adhering Example 1, the LCD display device adhering Embodiment 1 has a lower center brightness loss of 9.6%. At the same time, the LCD display device adhering Embodiment 1 has a greater brightness and color deviation viewing angle value (127.4° and 180.0°), while the brightness and color deviation viewing angle value of the LCD display device adhering example 1 are 114.6° and 141.5°.

Comprehensively considering the central brightness loss, the brightness, and the color deviation value viewing angle, the optical structure design of Embodiment 1 is more optimal.

### Embodiment 2

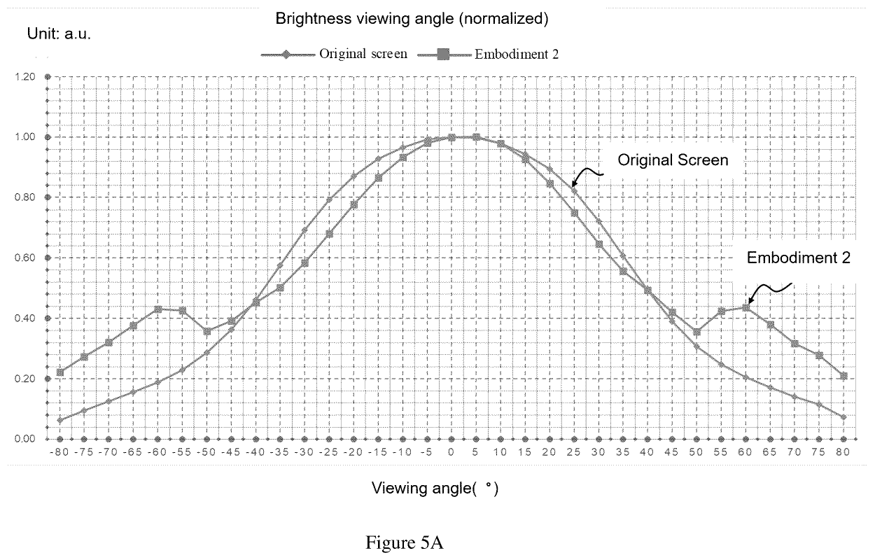

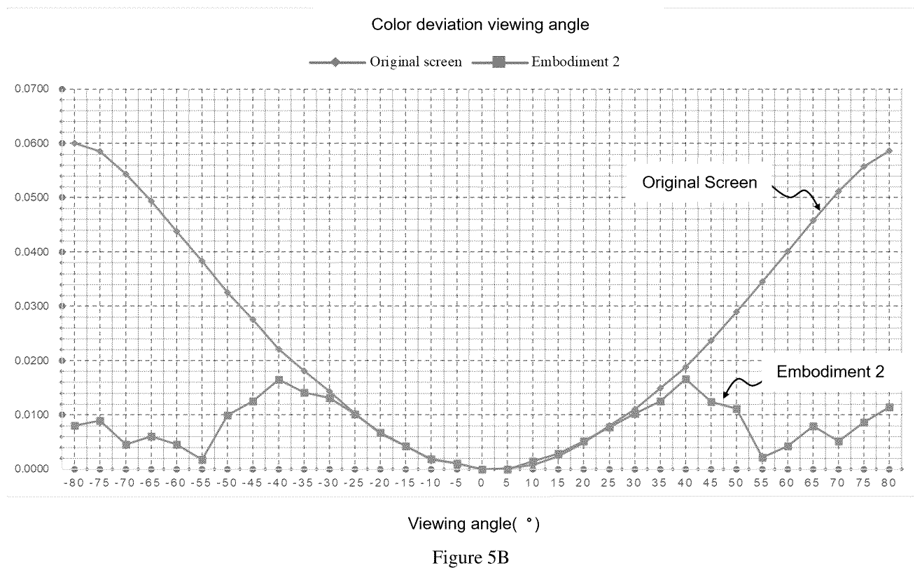

According to the optical functional thin film provided in Embodiment 1, wherein, Except for adjusting the refractive index N2 of the filling layer (the third layer of acrylic resin layer) to 1.43, the other designs of embodiment 2 are consistent with embodiment 1. FIG. 5A shows the brightness viewable curve of the LCD display device after adhering example 2. Compared to the original LCD display device, the brightness viewing angle of the LCD display device after adhering example 2 have been increased from 95.4° to 137.5°, and the center brightness has been reduced by 13.3%. Except for the maximum brightness value in the front viewing angle, new maximum brightness values (−60° and 60°) and minimum brightness values (−50° and 50°) appear in both the left and right brightness viewing angle curves. The difference between the maximum and minimum brightness values on the same viewing angle is about 7%. In the color deviation viewing angle curve (FIG. 5B), the color deviation values are uniformly increased in the range from −40° to −0° in the left viewing angle, but are significantly fluctuated in the range of −40° to −80°. In the right viewing angle, the color deviation value assumes a similar change of pattern. Although the color deviation value fluctuates greatly in the large viewing angle, the overall color deviation value is less than 0.02 within the testing range. As the LCD screen is shifted from a front viewing angle to a side viewing angle, the human eyes can perceive a significant change in color deviation.

### Embodiment 3

According to the optical functional thin film provided in Embodiment 1, wherein,

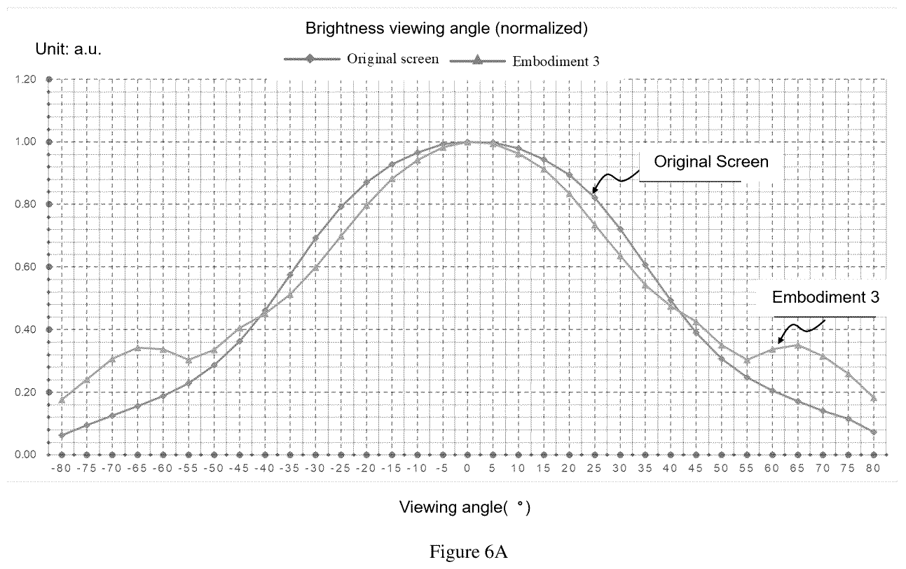

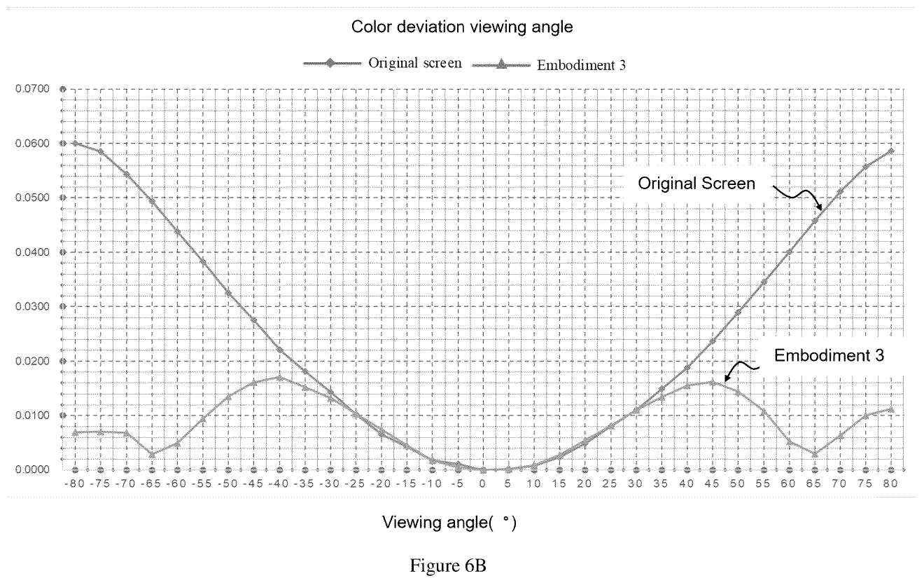

Except for adjusting the refractive index N2 of the filling layer (the third layer of acrylic resin layer) to 1.46, the other designs of embodiment 3 are consistent with embodiment 1. FIG. 6A shows the brightness viewing angle curve of the LCD display device after adhering example 3. Compared to the original LCD display device, the brightness viewing angle of the LCD display device after adhering example 3 has been increased from 95.4° to 133.8°, and the center brightness has been reduced by 9.92%. Except for the maximum brightness value in the front viewing angle, new maximum brightness values (−65° and 65°) and minimum brightness values (−55° and 55°) appear in both the left and right brightness viewing angle curves. The difference between the maximum and minimum brightness values on the same is about 4%. In the color deviation viewing angle curve (FIG. 6B), the color deviation values are uniformly increased in the range from −0° to −40° in the left viewing angle, are uniformly decreased in the range of −40° to −60°, and after reaching to the minimum value, and further, as the viewing angle increases, the color deviation value slightly increases.

In the right viewing angle, the color deviation value assumes a similar change of pattern. Compared to embodiment 2, the color deviation value is fluctuated decreased in the large viewing angle, and the color deviation value is less than 0.02 within the testing range. As the LCD screen is shifted from a front viewing angle to a side viewing angle, the human eyes can perceive a significant change in color deviation.

### Embodiment 4

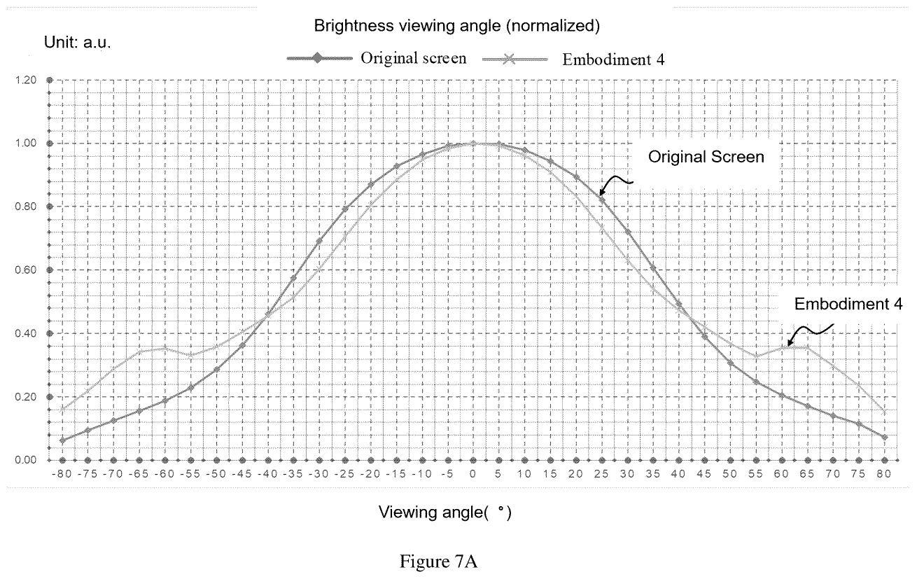

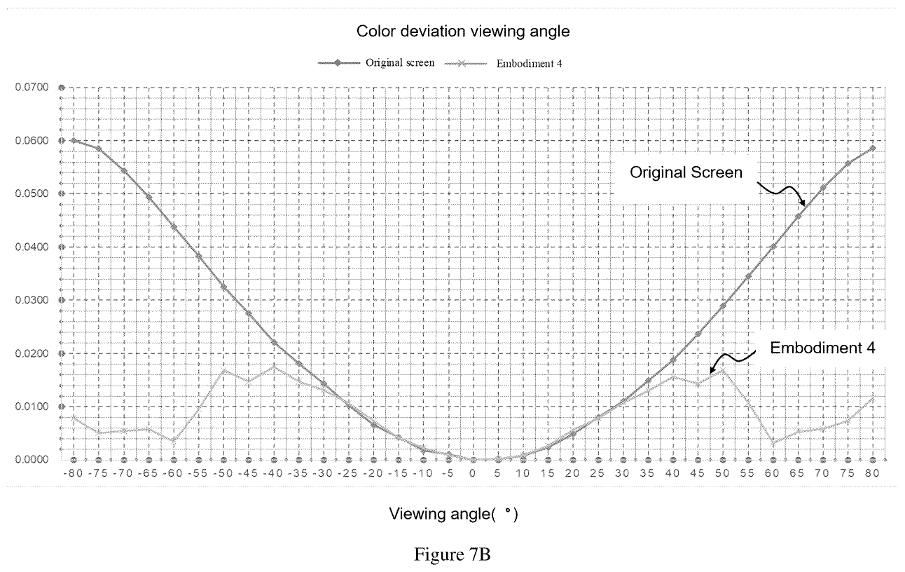

According to the optical functional thin film provided in embodiment 1, wherein, Except for adjusting the refractive index N2 of the third layer of acrylic resin to 1.48, the other designs in embodiment 4 are consistent with embodiment 1. FIG. 7A shows the brightness viewing angle curve of the LCD display device after adhering embodiment 4. Compared to the original LCD display device, the brightness viewing angle of the LCD display device after adhering embodiment 4 has been increased from 95.4° to 132.8°, and the center brightness has been reduced by 9.97%. Except for the maximum brightness value in the front viewing angle, new maximum brightness values (−60° and 60°) and minimum brightness values (−55° and 55°) appear in both the left and right brightness viewing angle curves. The difference between the maximum and minimum brightness values on the same side view is about 2%. In the color deviation viewing angle curve (FIG. 7B), the color deviation values are uniformly increased in the range from −0° to −40° in the left viewing angle, but the overall trend assumes a decrease followed by an increase in the range from −40° to −80° with a great fluctuation. In the right viewing angle, the color deviation value assumes a similar change of pattern. The color deviation value is less than 0.02 within the testing viewing angle. As the LCD screen is shifted from a front viewing angle to a side viewing angle, the human eyes can perceive a significant change in color deviation.

### Embodiment 5

According to the optical functional thin film provided in embodiment 1, wherein,

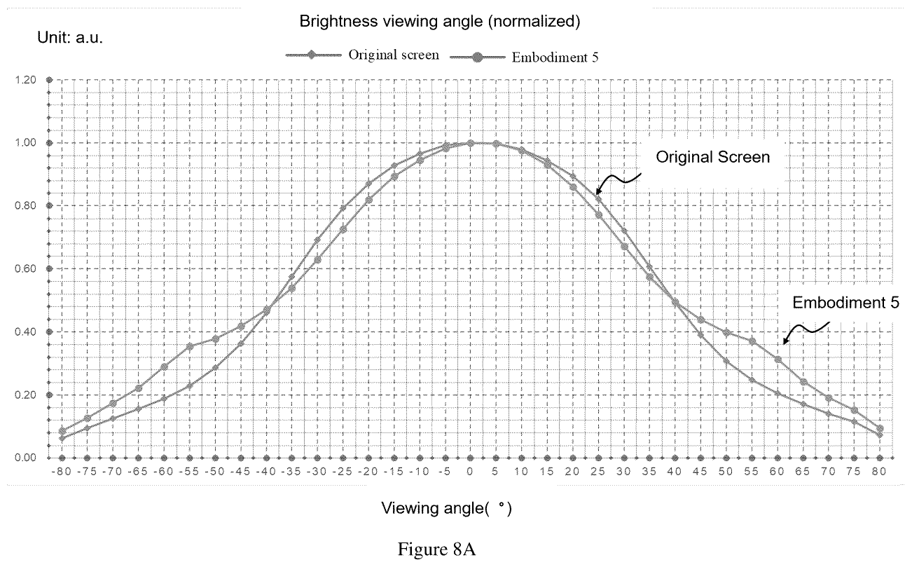

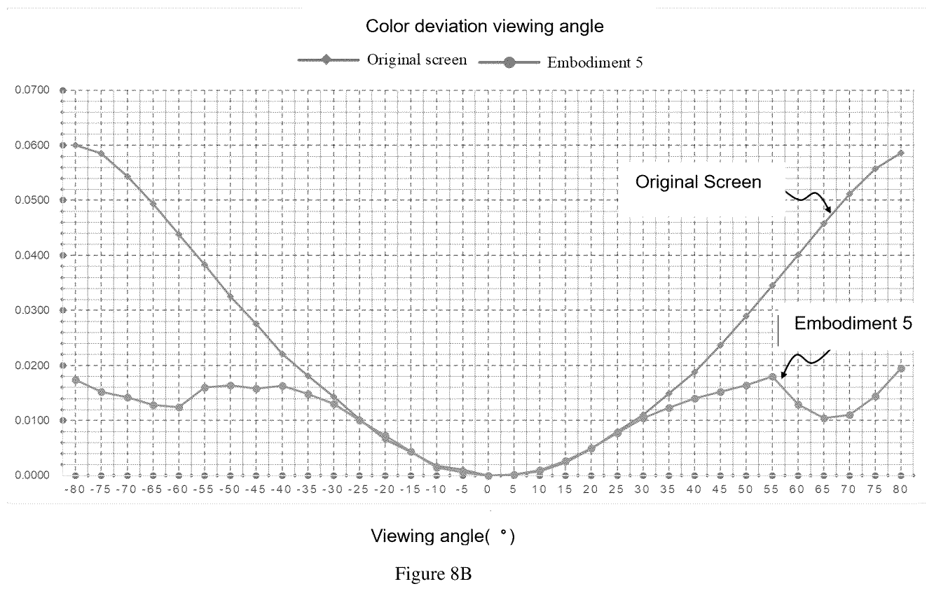

Except for adjusting the refractive index N2 of the third layer of acrylic resin to 1.53, the other designs in embodiment 5 are consistent with embodiment 1. FIG. 8A shows the brightness viewing angle curve of the LCD display device after adhering embodiment 5. Compared to the original LCD display device, the brightness viewing angle of the LCD display device after adhering embodiment 5 has been increased from 95.4° to 114.9°, and the center brightness has been reduced by 7.88%. Except for the maximum brightness value in the front side viewing angle, no new maximum brightness values and minimum brightness values appears in both the left and right brightness viewing angle curves. In the color deviation viewing angle curve (FIG. 8B), the color deviation values are uniformly increased in the range from −0° to −55° in the left side viewing angle, but a change of pattern of decrease followed by an increase in the range from −55° to −60°, and in the range from 60° to −80°. In the right side viewing angle, the color deviation value assumes a similar change of pattern. The color deviation value is less than 0.02 within the testing viewing angle. As the LCD screen is shifted from a front viewing angle to a side viewing angle, the human eyes can perceive a significant change in color deviation.

TABLE 2
Viewing angle test data for center brightness loss, brightness and color deviation viewing angle
of the original LCD display device and the LCD display device adhering embodiments 1-5

| | | | | The center | The | The color |
|---|---|---|---|---|---|---|
| | The refractive | The refractive | The center | brightness | brightness | deviation |
| | index of the | index of the | brightness | loss | viewing angle | viewing angle |
| Items | second lay N1 | third layer N2 | (cd/m²) | (%) | (°) | (°) |
| Original screen | / | / | 234.8 | 0.0 | 95.4 | 78.6 |
| Embodiment 1 | 1.62 | 1.50 | 213.6 | 9.03 | 125.7 | 180.0 |
| Embodiment 2 | 1.62 | 1.43 | 203.6 | 13.29 | 137.5 | 180/0 |
| Embodiment 3 | 1.62 | 1.46 | 211.5 | 9.92 | 133.8 | 180/0 |
| Embodiment 4 | 1.62 | 1.48 | 211.4 | 9.97 | 132.8 | 180.0 |
| Embodiment 5 | 1.62 | 1.53 | 216.3 | 7.88 | 114.9 | 180.0 |

As shown in Table 2, after adhering the optical functional thin film of embodiments 1-5, as the difference of the refractive index between the optical structure layer and the filling layer decreases (embodiments 1-5), the uniformity of the brightness angle curve distribution of the liquid crystal display device increases, and the brightness extreme value in the corresponding angle area gradually decreases until it disappears. Meanwhile, the central brightness loss assumes a downward trend. Synthetically considering the central brightness loss and the brightness viewing angle (>120)°, embodiments 1˜4 are preferred as preferred embodiments.

Except for the brightness viewing angle, the color deviation viewing angle is similarly an important performance indicator. In the CIE1976 (u′, v′) coordinates, the color deviation value Δu′v′ is a no unit indicator that measures the change of color deviation under the different viewing angles, and defined as Δu′v′=[{u′ (different viewing angles)−u′ (positive viewing angle)}²+{v′ (different viewing angles)-v′ (positive viewing angle)}²]^{1/2}. The larger the color deviation value Δu′v′, the more significant the color deviation phenomenon. The color deviation value of the original LCD display device gradually increases with the increase of the viewing angle, and no new maximum value appears in the curve. At this time, the human eyes can perceive the screen gradually changing from white in the front view to yellow in the side view, and no feeling of abrupt change in the color deviation value as the viewing angle increases. When measuring the color deviation viewing angle of the liquid crystal display device based on Δu′v′, the liquid crystal display device not adhering the optical functional thin films has about 80% of the color deviation viewing angle. However, in the color deviation viewing angle curve of the LCD display device after adhering embodiments 1-5, a new maximum value of the color deviation value appears at a specific viewing angle. When switching from a front view to a side view, the human eyes can perceive a abrupt change in the color deviation near the corresponding maximum value, which greatly affects the subjective perception of viewing LCD device. The obviousness of the abrupt process is influenced by the difference between the maximum color deviation value and the deviation value of the adjacent next viewing angle.

### Embodiment 6

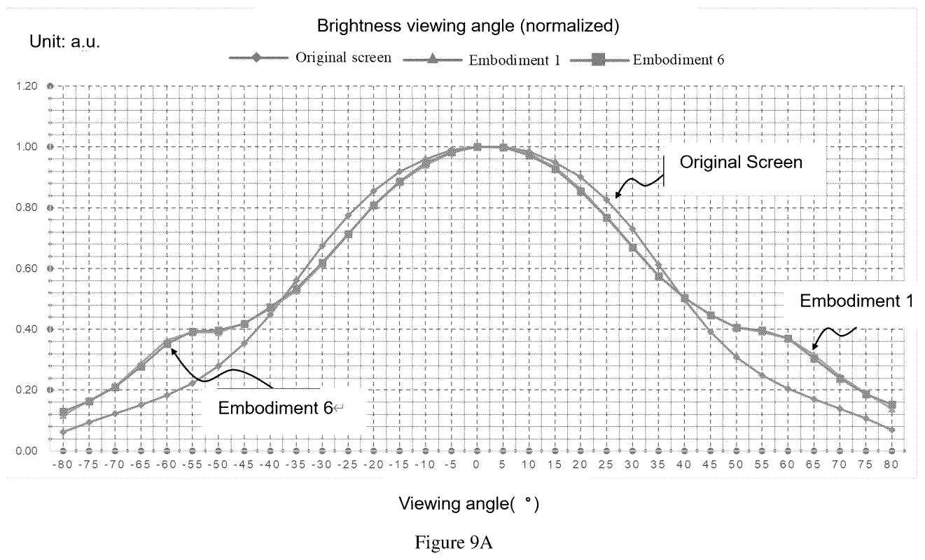

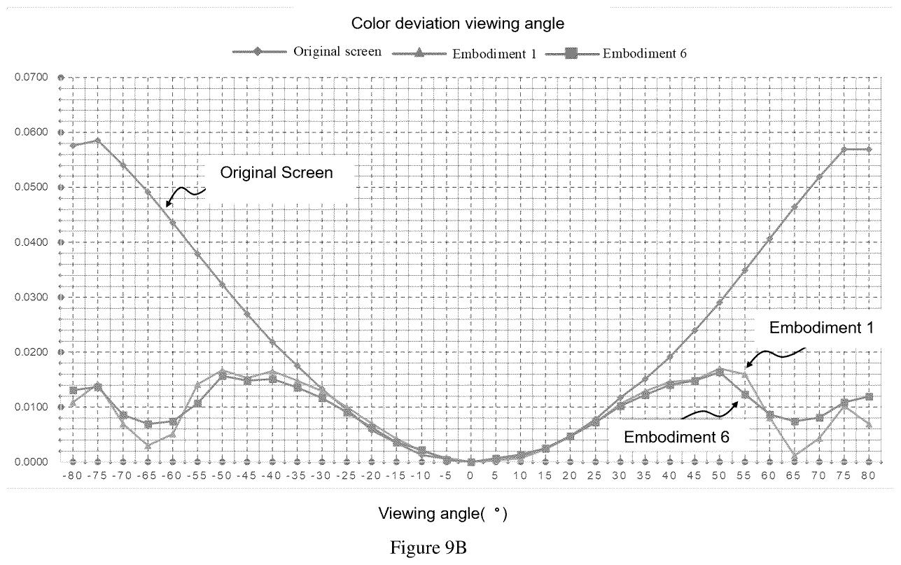

According to the optical functional thin film provided in embodiment 1, wherein, in order to enhance the subjective feelings of the LCD display device after adhering the optical film, a fluctuating structure with roughness is further formed on the filling layer (away from the trapezoidal structure side) in embodiment 6 based on embodiment 1. When the light is partially emitted outwardly through the undulating structure, it will further refract and achieve a uniform light effect. As shown in FIG. 9A, compared to the liquid crystal display device adhering embodiment 1, the brightness viewing angle of the liquid crystal display device adhering embodiment 6 descends from 214.4° to 212.4°, the central brightness loss increases from 8.30% to 9.15%. Except for the maximum brightness of the front view, no new brightness extreme values appearing in the left and right side views on the brightness angle curves. The brightness viewing angle curves of embodiment 1 and embodiment 6 almost overlap after normalization, and embodiment 6 is closer to the inner side, resulting in a decrease in the viewing angle. As the viewing angle increases, the brightness value decreases uniformly. Meanwhile, in the color deviation viewing curve (FIG. 9B), the color deviation value assumes a uniformly increasing trend within the range of the left side view of −0° to −50°, after that, it assumes a pattern of change of decreasing followed by increasing within the range of −55 to −65°, 65° to −80°. The color deviation value assumes a similar pattern of change in the right side view. Specifically, compared to embodiment 1, after increasing the haze on the side of the filling layer, in the area of the viewing angle corresponding to −55° to −60°, the declining rate of the color deviation value retards. That is, the change of the color deviation of the LCD display device adhering embodiment 1 decreases from 0.0157 to 0.0107, decreasing of 0.005, while the color deviation value of the LCD display device adhering embodiment 6 in the corresponding viewing angle decreases from 0.0167 to 0.0141, decreasing of 0.002. As the LCD screen is shifted from a front view to a side view, the process of the abrupt change in the color deviation that can be perceived by the human eyes is significantly reduced.

TABLE 3
The test data of the center brightness loss, the brightness, and the
color deviation viewing angle of the original LCD display device and after
adhering embodiments 1 and 6

| | The refractive | The refractive index | | | Horizontal |
|---|---|---|---|---|---|
| | index of the | of the third layer | The fourth | Center brightness | viewing angle of |
| Items | second lay N1 | N2 | bonding layer | loss | Brightness |
| Original screen | / | / | / | 0.0 | 94.9 |
| Embodiment 1 | 1.62 | 1.50 (0% Haze) | OCA adhesive | 8.30 | 125.5 |
| | | | tape | | |
| Embodiment 6 | 1.62 | 1.50 (25% Haze) | OCA adhesive | 9.15 | 124.1 |
| | | | tape | | |

As shown in Table 3, when the filling layer increases from 0% haze (embodiment 1) to 25% haze (embodiment 6), the center brightness loss increases by 0.85%, and the brightness viewing angle decreases by 1.4°, However, the increase in haze is beneficial in reducing the fluctuation of the color deviation values near the maximum value when the viewing angle is shifted, making it difficult for the human eyes to perceive the abrupt change in the color deviation values.

Furthermore, the present invention further evaluates and confirms influences of the first characteristic value t on the central brightness loss, brightness, and color deviation viewing angle of the optical functional thin film.

### Embodiment 7

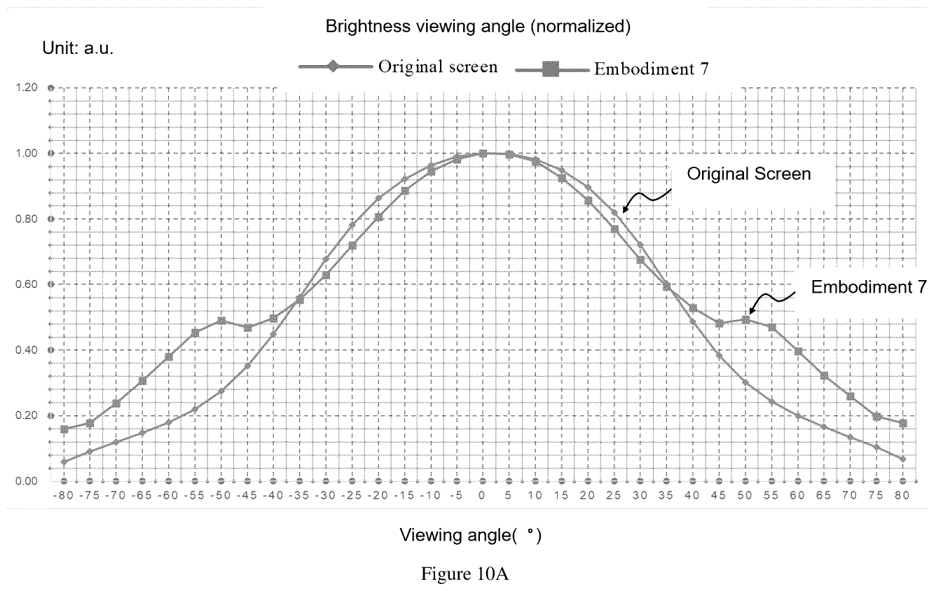

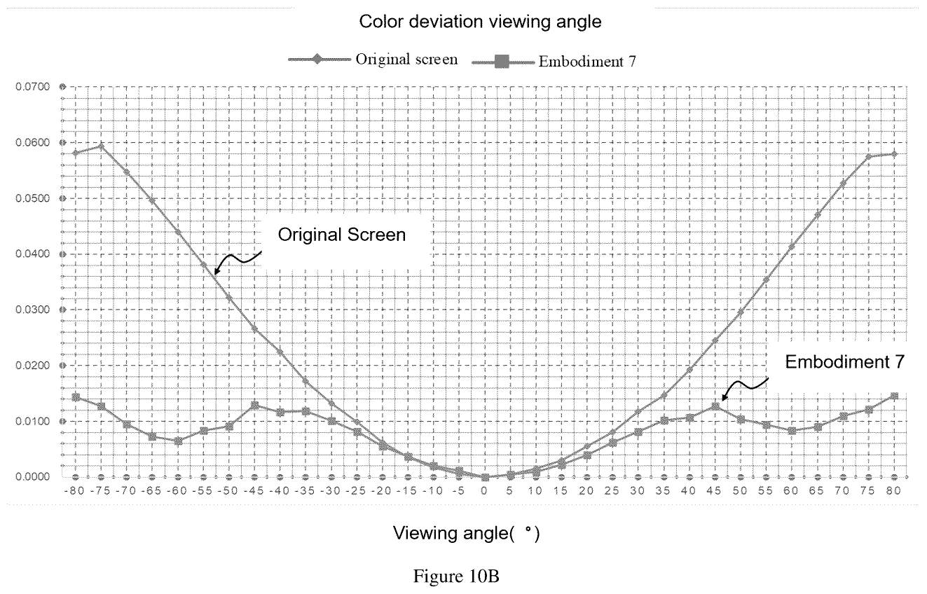

According to the optical functional thin film provided in embodiment 6, wherein, The optical structure design of embodiment 7 is similar to that of embodiment 6, except that the first characteristic value t of the microstructure in the optical structure layer is adjusted to 28.74%. As shown in FIG. 10A, compared to the original LCD display device, the brightness viewing angle of the LCD display screen after adhering embodiment 7 increases from 94.3° to 127.5°, the center brightness loss of decreases 11.93%. Except for the maximum brightness value in the front view, there is a maximum brightness value and a minimum brightness value in the area of −40° to −55° of the left side view, and in the area of 40 to 55° of the right side view, equally; and the difference between the maximum brightness value and the minimum brightness value on the same side view is about 2%. In the color deviation viewing angle curve (FIG. 10B), the maximum value of the color deviation assumes in the left side viewing angle of −45° and the right side viewing angle of 50°. In the left side viewing area, the change value of the color deviation value is the most significant with the viewing angle from −45° shifting to −50°, with the fluctuation value (Δu′v′−50°-Δu′v′−45°) of −0.0038. In the right side viewing angle, the change value of the color deviation value is the most significant with the viewing angle from 45° shifting to 50°, with the fluctuation value (Δu′v′_{50°}-Δu′v′_{45°}) of −0.0023. In the tested viewing angle area, the color deviation values are all less than 0.02.

### Embodiment 8

According to the optical functional thin film provided in embodiment 6, wherein,

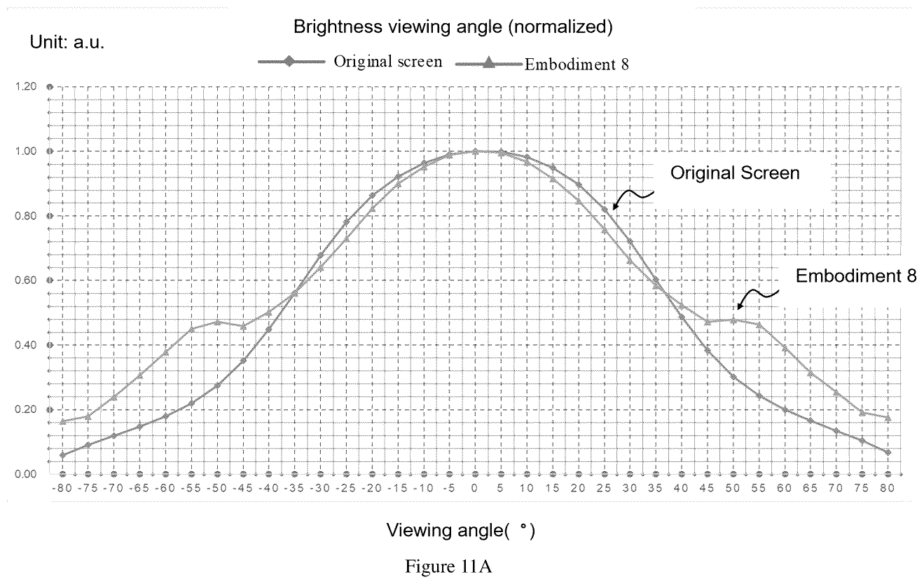

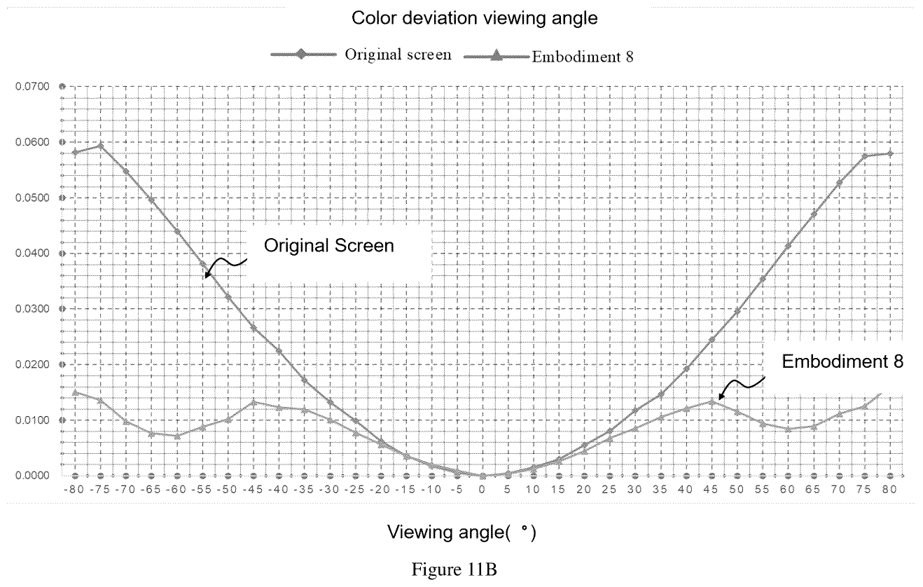

The optical structure design of embodiment 8 is similar to embodiment 6, except that the first characteristic value t of the microstructure in the optical structure layer is adjusted to 28.48%. As shown in FIG. 11A, compared to the original LCD display device, the brightness viewing angle of the LCD display screen adhering embodiment 7 increases from 94.3° to 126.9°, the center brightness loss is 12.48%. Except for the maximum brightness value in the front view, there is a maximum brightness value and a minimum brightness value in the area of −40° to −55° of the left side view, and in the area of 40 to 55° of the right side view, equally; and the difference between the maximum brightness value and the minimum brightness value on the same side view is about 1%. In the color deviation viewing angle curve (FIG. 11B), the maximum value of the color deviation assumes in the left side viewing angle of −45° and the right side viewing angle of 50°. In the left side viewing area, the change value of the color deviation value is the most significant with the viewing angle from −45° shifting to −50°, with the fluctuation value (Δu′v′−50°-Δu′v′−45°) of −0.0031. In the right side viewing angle, the change value of the color deviation value is the most significant with the viewing angle from 45° shifting to 50°, with the fluctuation value (Δu′v′_{50°}-Δu′v′_{45°}) of −0.0019. In the tested viewing angle area, the color deviation values are all less than 0.02.

### Embodiment 9

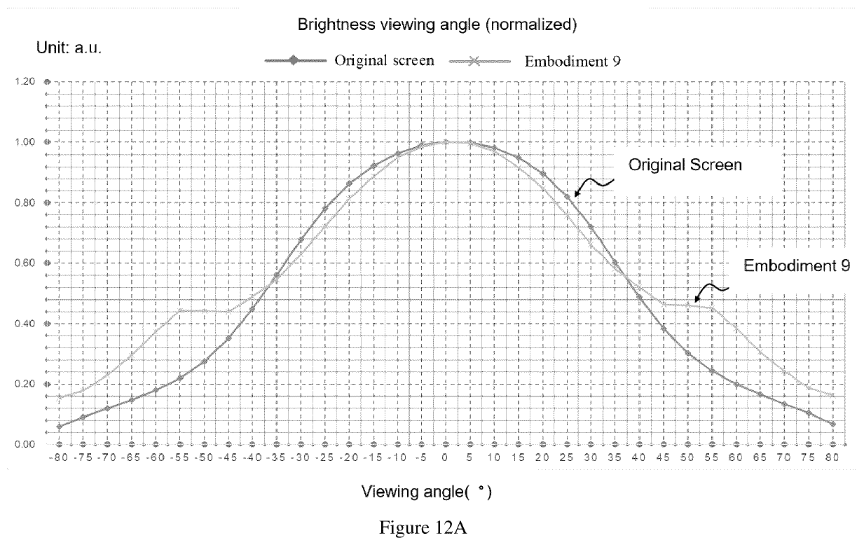

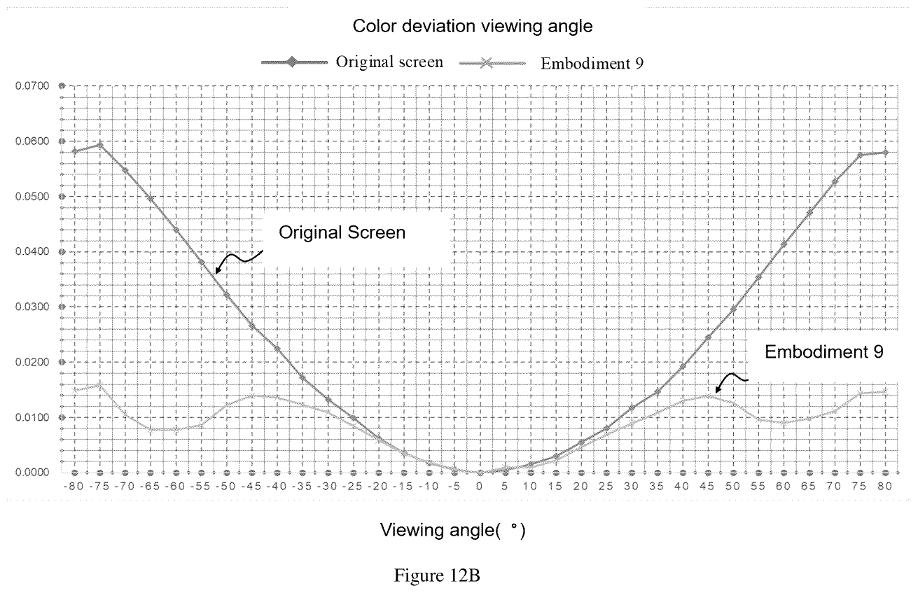

The optical structure design of embodiment 9 is similar to embodiment 6, except that the first characteristic value t of the microstructure in the optical structure layer is adjusted to 28.74%. As shown in FIG. 12A, compared to the original LCD display device, the brightness viewing angle of the LCD display screen after adhering embodiment 9 increases from 94.3° to 125.8°, the center brightness loss is 11.17%. Except for the maximum brightness value in the front view, there is no brightness extreme values in the left side view, and the right side view, equally; the brightness decreases gradually with the viewing angle increasing. In the color deviation viewing angle curve (FIG. 12B), the maximum value of the color deviation values assumes in the left side viewing angle of −45° and the right side viewing angle of 45°. In the left side viewing area, the change value of the color deviation value is the most significant with the viewing angle from −50° shifting to −55°, with the fluctuation value (Δu′v′−55°-Δu′v′-50°) of −0.0036 and the fluctuation value (Δu′v′_{55°}-Δu′v_{50°}) of −0.0030, respectively. The change value of the color deviation value (Δu′v′−50°-Δu′v′-45°) and (Δu′v′50°-Δu′v′45°) are −0.0018 and −0.0013, respectively, with the viewing angle from −45° shifting to −50°. In the tested viewing angle area, the color deviation values are all less than 0.02.

### Embodiment 10

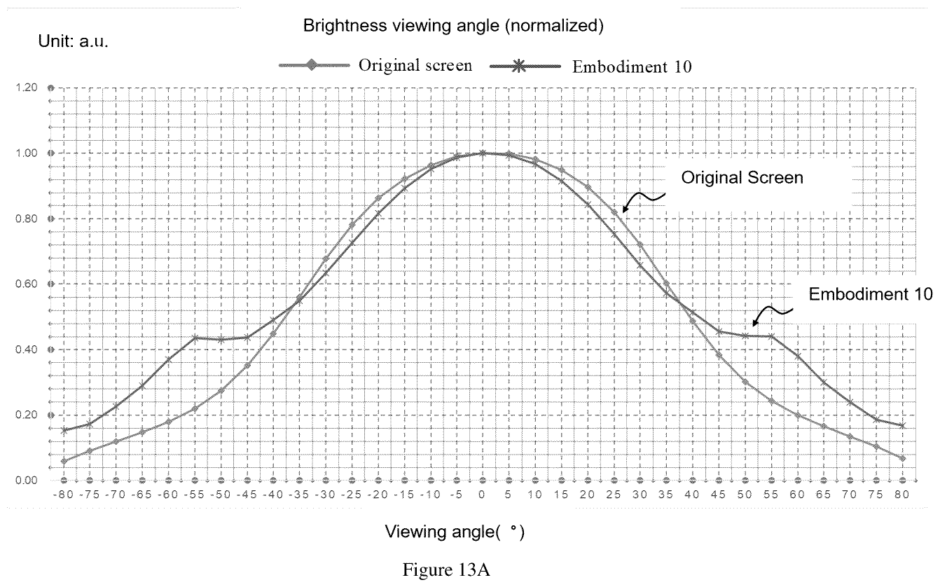

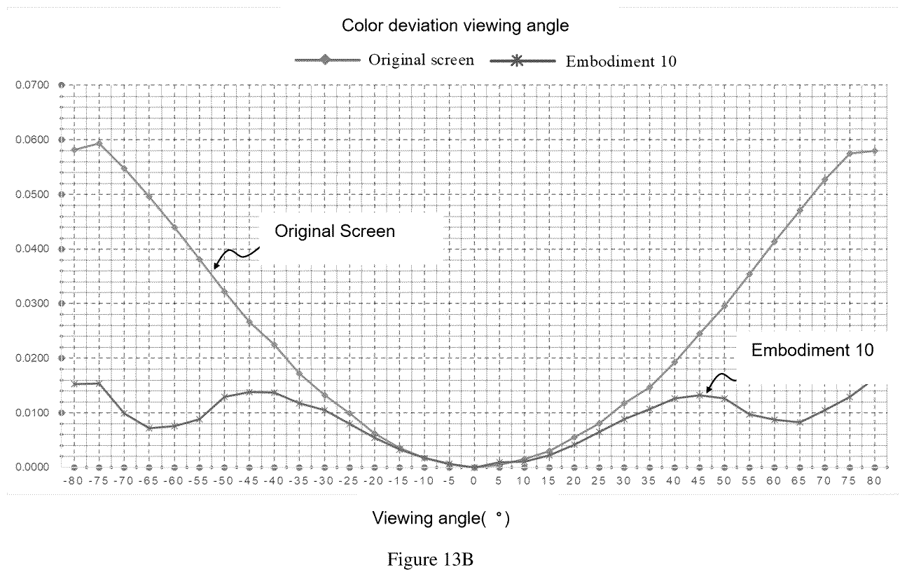

The optical structure design of embodiment 10 is similar to embodiment 6, except that the first characteristic value t of the microstructure in the optical structure layer is adjusted to 27.45%. As shown in FIG. 13A, compared to the original LCD display device, the brightness viewing angle of the LCD display screen after adhering embodiment 10 increases from 94.3° to 125.2°, the center brightness loss is 11.13%. Except for the maximum brightness value in the front view, there is no brightness extreme values in the left side view, and the right side view, equally; the brightness decreases gradually with the viewing angle increasing. In the color deviation viewing angle curve (FIG. 13B), the maximum value of the color deviation values assumes in the left side viewing angle of −45° and the right side viewing angle of 45°. In the left side viewing area, the change value of the color deviation value is the most significant with the viewing angle from −50° shifting to −55° and from 50° shifting to 55°, with the fluctuation value (Δu′v′−55°-Δu′v′−50°) of −0.0041 and the fluctuation value (Δu′v′55°-Δu′v50°) of −0.0029, respectively. The change value of the color deviation value (Δu′v′−50°-Δu′v′-45°) and (Δu′v′50°-Δu′v′45°) are −0.0009 and −0.0006, respectively, with the viewing angle from −45° shifting to −50°. In the tested viewing angle area, the color deviation values are all less than 0.02.

### Embodiment 11

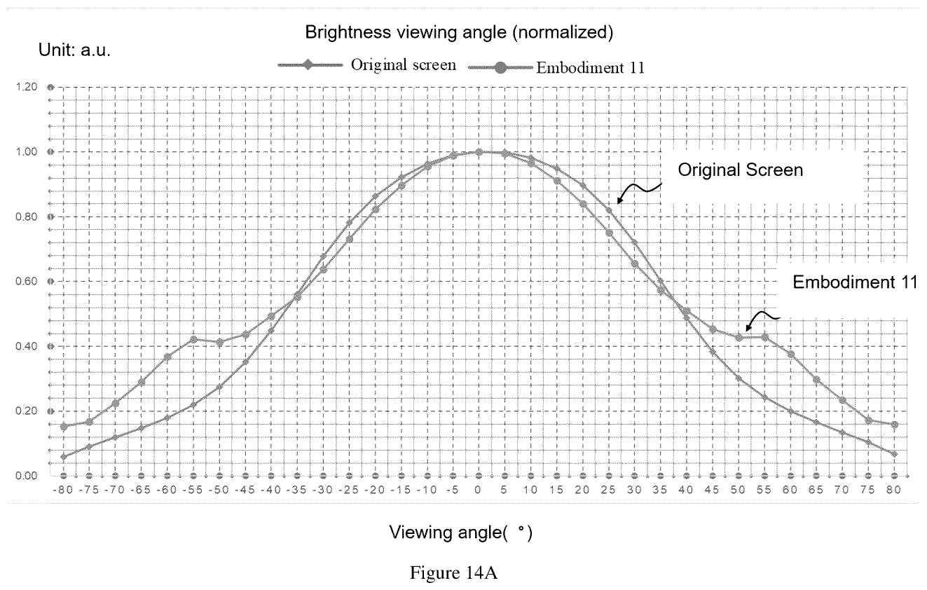

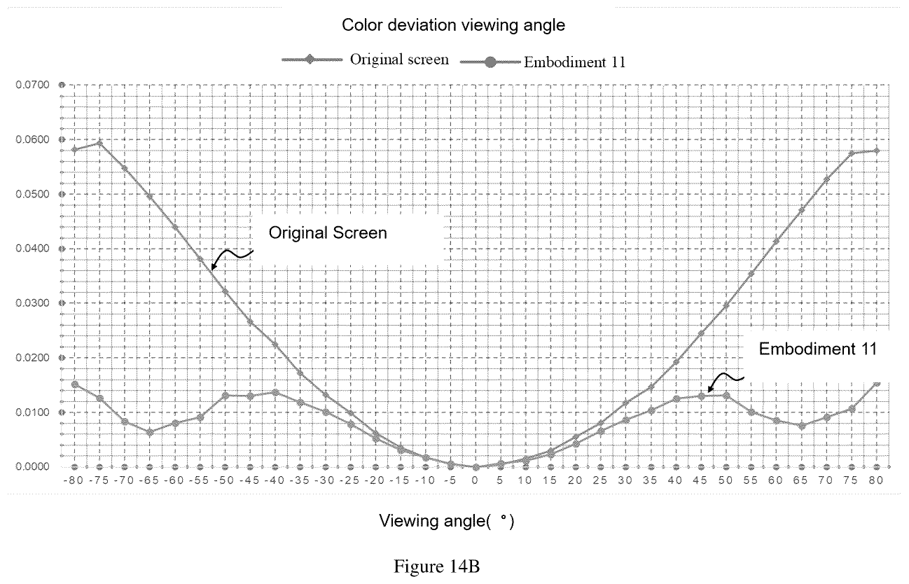

The optical structure design of embodiment 11 is similar to embodiment 6, except that the first characteristic value t of the microstructure in the optical structure layer is adjusted to 27.17%. As shown in FIG. 14A, compared to the original LCD display device, the brightness viewing angle of the LCD display screen after adhering embodiment 11 increases from 94.3° to 125.0°, the center brightness loss is 11.17%. Except for the maximum brightness value in the front view, there is new maximum brightness value and a minimum brightness value in the area of −45° to −60° of the left side view, and the difference between the maximum brightness value and the minimum brightness value is about 1%. However, there is no new extreme values in the right side viewing area of 45° to 60°. In the color deviation viewing angle curve (FIG. 14B), the maximum value of the color deviation values assumes in the left side viewing angles of −40° and −50°, and the right side viewing angle of 50°. In the left side viewing area, the change value of the color deviation value is the most significant with the viewing angle from −50° shifting to −55° and from 50° shifting to 55°, with the fluctuation value (Δu′v′−55°-Δu′v′−50°) of −0.0040 and the fluctuation value (Δu′v′55°-Δu′v50°) of −0.0030, respectively. The change values of the color deviation value (Δu′v′−50°-Δu′v′−45°) and (Δu′v′50°-Δu′v′45°) are 0.0001 and 0.0001, respectively, with the viewing angle from −45° shifting to −50°. In the tested viewing angle area, the color deviation values are all less than 0.02.

### Embodiment 12

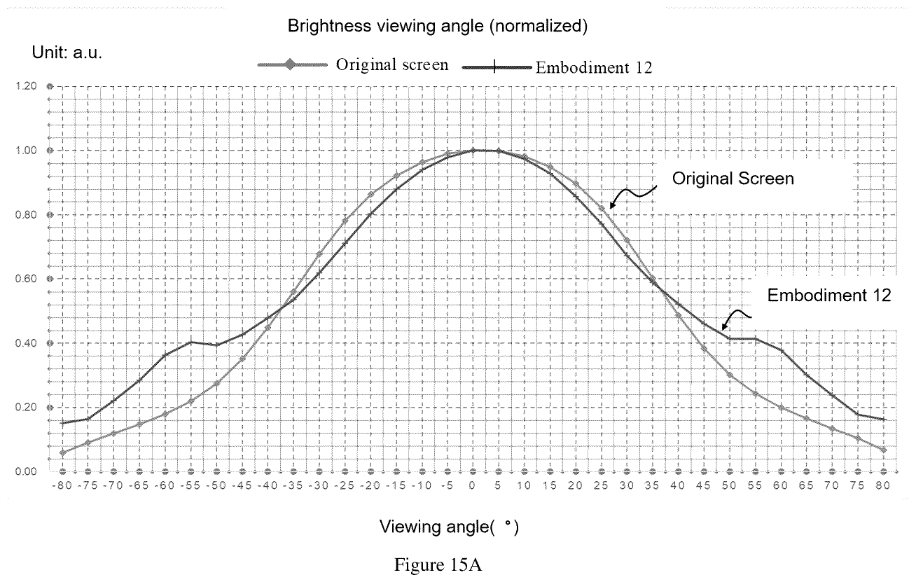

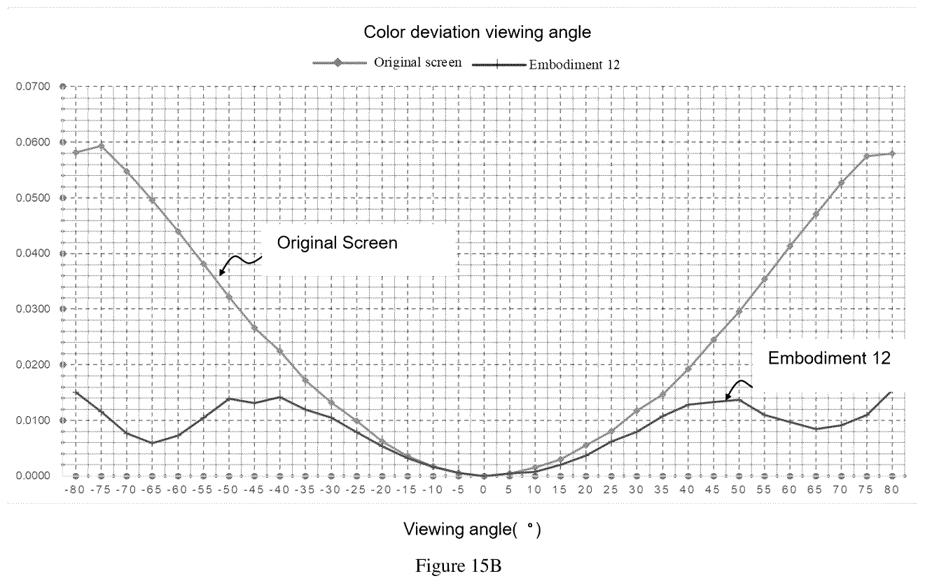

The optical structure design of embodiment 12 is similar to embodiment 6, except that the first characteristic value t of the microstructure in the optical structure layer is adjusted to 26.97%. As shown in FIG. 15A, compared to the original LCD display device, the brightness viewing angle of the LCD display screen after adhering embodiment 12 increases from 94.3° to 124.8°, the center brightness loss is 12.48%. Except for the maximum brightness value in the front view, there is new maximum brightness value and a minimum brightness value in the area of −45° to −60° of the left side view, and the difference between the maximum brightness value and the minimum brightness value is about 1%. However, there is no new extreme values in the right side viewing area of 45° to 60°. In the color deviation viewing angle curve (FIG. 15B), the maximum value of the color deviation values assumes in the left side viewing angles of −40° and −50°, and the right side viewing angle of 50°. In the left side viewing area, the change value of the color deviation value is the most significant with the viewing angle from −50° shifting to −55° and from 50° shifting to 55°, with the fluctuation value (Δu′v′−55°-Δu′v′−50°) of −0.0034 and the fluctuation value (Δu′v′55°-Δu′v50°) of −0.0027, respectively. The change values of the color deviation value (Δu′v′−50°-Δu′v′−45°) and (Δu′v′50°-Δu′v′45°) are −0.0008 and −0.0004, respectively, with the viewing angle from −45° shifting to −50°. In the tested viewing angle area, the color deviation values are all less than 0.02.

### Embodiment 13

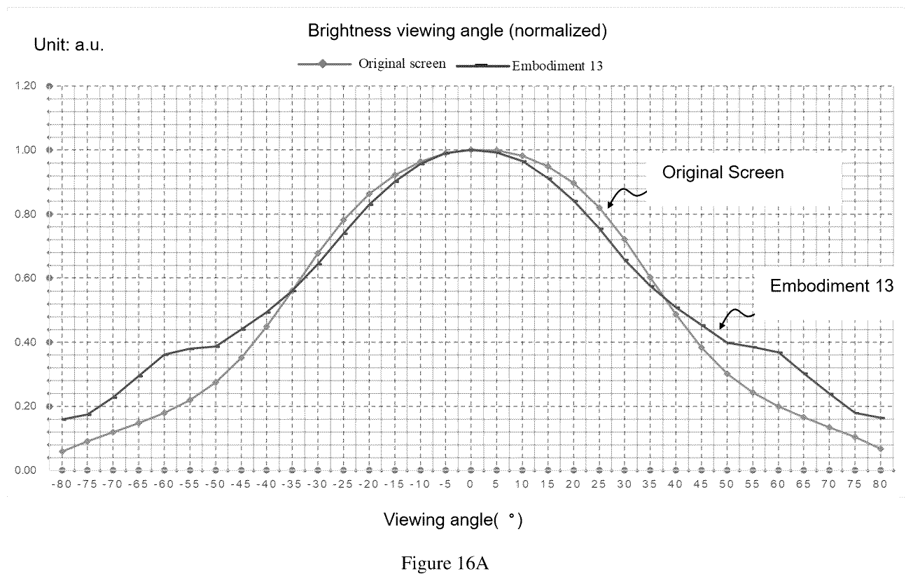

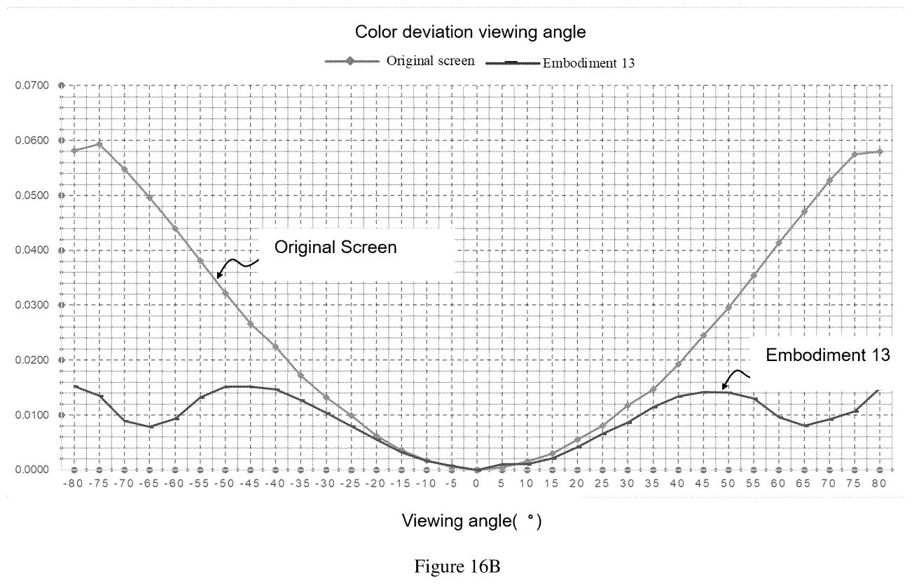

The optical structure design of embodiment 13 is similar to embodiment 6, except that the first characteristic value t of the microstructure in the optical structure layer is adjusted to 24.50%. As shown in FIG. 16A, compared to the original LCD display device, the brightness viewing angle of the LCD display screen after adhering embodiment 13 increases from 94.3° to 124.8°, the center brightness loss is 10.58%. Except for the maximum brightness value in the front view, there is no new extreme value in the areas of the left side view and the right side view. In the color deviation viewing angle curve (FIG. 16B), the maximum value of the color deviation values assumes in the left side viewing angles of −45° and −50°, and the right side viewing angle of 50°. In the left side viewing area, the change value of the color deviation value is the most significant with the viewing angle from −55° shifting to −60° and from 55° shifting to 60° with the fluctuation value (Δu′v′−55°-Δu′v′−50°) of −0.0029 and the fluctuation value (Δu′v′55°-Δu′v50°) of −0.0024 respectively. The fluctuation values of the color deviation value (Δu′v′−50°-Δu′v′−45°) and (Δu′v′50°-Δu′v′45°) are 0 and −0.0001, respectively, with the viewing angle from −45° shifting to −50°. In the tested viewing angle area, the color deviation values are all less than 0.02.

### Embodiment 14

According to the optical functional thin film provided in embodiment 6, wherein,

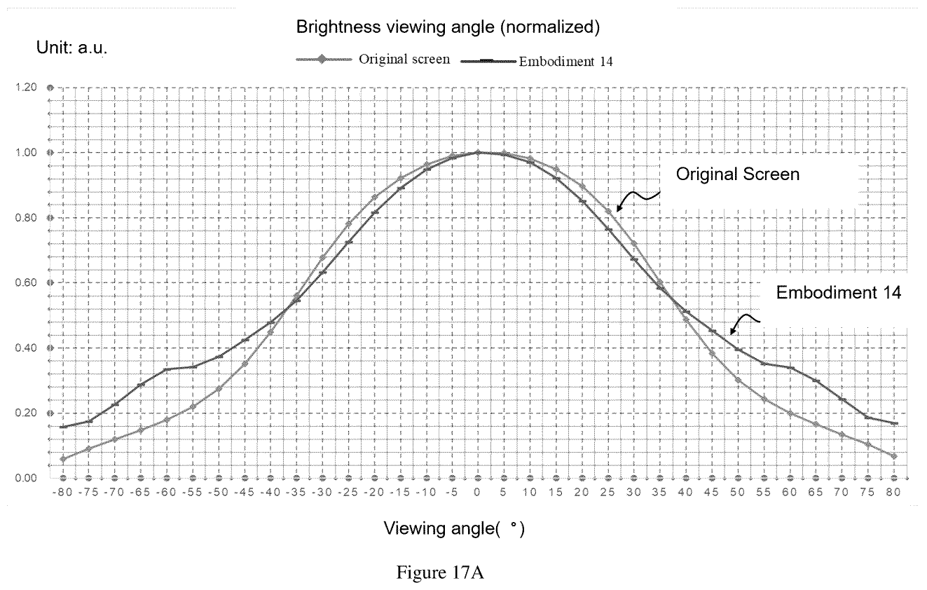

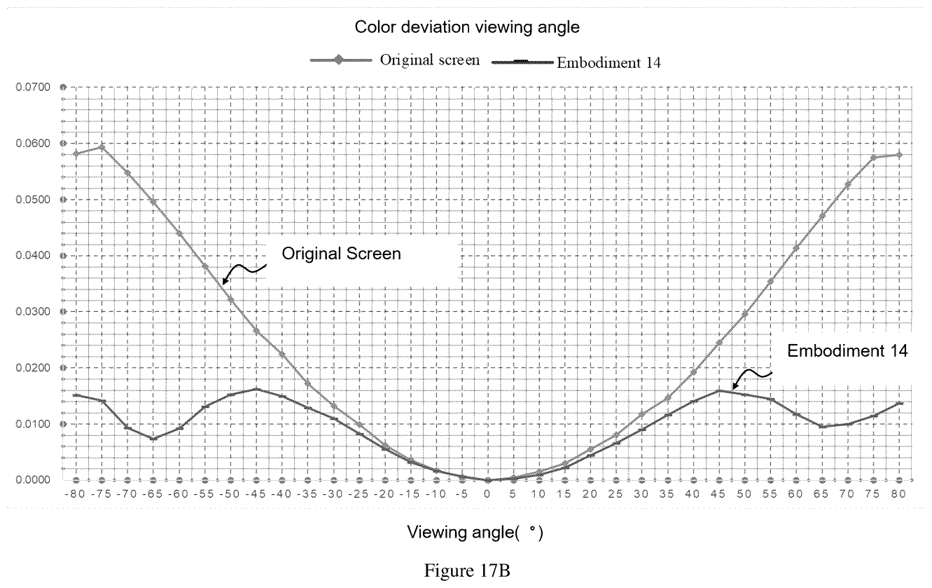

The optical structure design of embodiment 14 is similar to embodiment 6, except that the first characteristic value t of the microstructure in the optical structure layer is adjusted to 23.61%. As shown in FIG. 17A, compared to the original LCD display device, the brightness viewing angle of the LCD display screen after adhering embodiment 14 increases from 94.3° to 120.9°, the center brightness loss is 10.37%. Except for the maximum brightness value in the front view, there is no new extreme value in the areas of the left side view and the right side view. In the color deviation viewing angle curve (FIG. 17B), the maximum value of the color deviation values assumes in the left side viewing angle of −45°, and the right side viewing angle of 45°. In the area of the left side viewing, the change value of the color deviation value is the most significant with the viewing angle from −55° shifting to −60° and from 55° shifting to 60°, with the fluctuation value (Δu′v′−60°-Δu′v′−55°) of −0.0039 and the fluctuation value (Δu′v′60°-Δu′v55°) of −0.0028, respectively. The fluctuation values of the color deviation value (Δu′v′−50°-Δu′v′−45°) and (Δu′v′50°-Δu′v′45°) are −0.0010 and −0.0007, respectively, with the viewing angle from −45° shifting to −50°. In the tested viewing angle area, the color deviation values are all less than 0.02.

### EXAMPLE 2

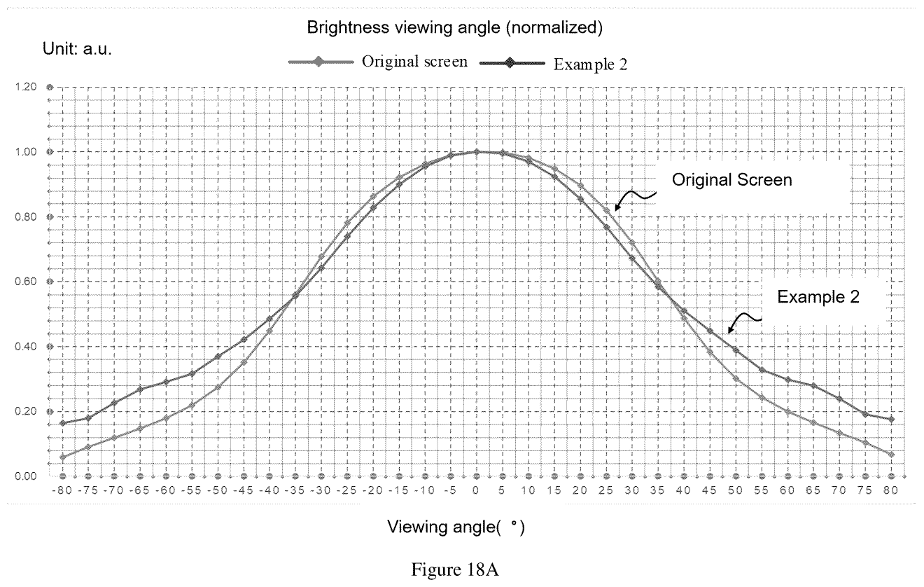

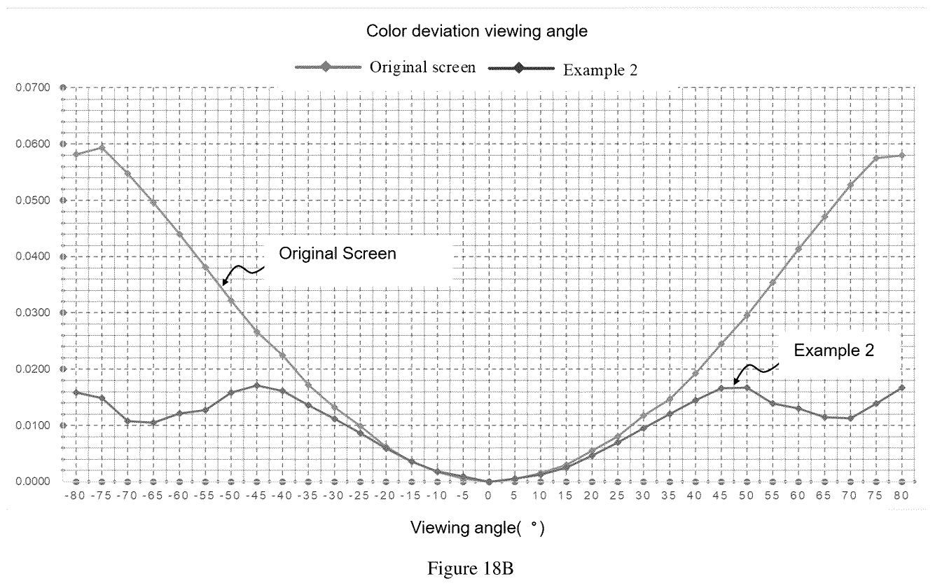

The optical structure design for example 2 is similar to embodiment 6, except that the first characteristic value t of the microstructure in the optical structure layer is adjusted to 21.40% (depth h is 8.98 μm). As shown in FIG. 18A, compared to the original LCD display device, the brightness viewing angle of the LCD display screen adhering embodiment 11 increases from 94.3° to 108.0°, the center brightness loss is 10.37%. Except for the maximum brightness value in the front view, there is no new extreme value in areas of the left and right viewing angles. In the color deviation viewing angle curve (FIG. 18B), the extreme value of the color deviation value appears in the left side view of −45° and the right side view of 50°. In the the left viewing area, the change value of the color deviation value is the most significant with the viewing angle from −50° shifting to −55° and 50°, and from 50° shifting to 55°, with the fluctuation value (Δu′v′−55°-Δu′v′−50°) of −0.0031 and the fluctuation value (Δu′v′55°-Δu′v50°) of −0.0028, respectively. The fluctuation values of the color deviation value (Δu′v′−50°-Δu′v′−45°) and (Δu′v′50°-Δu′v′45°) are −0.0013 and −0.0001, respectively, with the viewing angle from −45° shifting to −50°. In the tested viewing angle area, the color deviation values are all less than 0.02.

Table 3 shows the test data of the center brightness loss, brightness viewing angle, etc. of the LCD display device after adhering embodiments 7-14 and example 2. As the first characteristic value t decreases, the central brightness loss and the brightness viewing angle of the liquid crystal display device after adhering the optical functional thin film show a gradually decreasing trend. When the first characteristic t is 23.61%, the brightness viewing angle of the LCD display device adhering embodiment 14 is 120.9°. When the first characteristic t further decreases to 21.40%, the brightness viewing angle of the LCD display device adhering example 2 decreases to 108.0°. If it is required that the liquid crystal display device adhering this optical film can have a viewing angle greater than 120°, the first characteristic value t of the repeated microstructure in the optical structure layer needs to be greater than 23.61%, the preferred embodiment is 7-14 are the preferred embodiments.

TABLE 4
Test Data for the center brightness Loss and brightness viewing Angle
of the original LCD Display device and adhering examples 7-14. and example 2

| | | | | | Brightness |
|---|---|---|---|---|---|
| | The second layer | The third layer | First characteristic | Center brightness | viewing |
| | refractive index | refractive index | value | Loss | angle |
| Items | N1 | N2 | t | (%) | (°) |
| Original screen | / | / | / | 0.0 | 94.3 |
| Embodiment7 | 1.62 | 1.50 (25% | 28.74% | 11.93 | 127.5 |
| | | Haze) | | | |
| Embodiment 8 | 1.62 | 1.50 (25% | 28.48% | 12 48 | 126.9 |
| | | Haze) | | | |
| Embodiment 9 | 1.62 | 1.50 (25% | 27.59% | 11.17 | 125.8 |
| | | Haze) | | | |
| Embodiment 10 | 1.62 | 1.50 (25% | 27.45% | 11.13 | 125.2 |
| | | Haze) | | | |
| Embodiment 11 | 1.62 | 1.50 (25% | 27.17% | 11.17 | 125.0 |
| | | Haze) | | | |
| Embodiment 12 | 1.62 | 1.50 (25% | 26.97% | 12 48 | 124.9 |
| | | Haze) | | | |
| Embodiment 13 | 1.62 | 1.50 (25% | 24.50% | 10.58 | 124.8 |
| | | Haze) | | | |
| Embodiment 14 | 1.62 | 1.50 (25% | 23.61% | 10.83 | 120.9 |
| | | Haze) | | | |
| Example 2 | 1.62 | 1.50 (25% | 21.40% | 10.37 | 108.0 |
| | | Haze) | | | |

Furthermore, Table 5 shows the test data of the color deviation viewing angle of the original LCD display device and adhering embodiments 7-14, example 2. The LCD display device adhering embodiment 7 has a maximum color deviation value at the left side viewing angle of −45° and the right side viewing angle of 45°, respectively. Wherein, the maximum color deviation value at the viewing angle of −45° is 0.0129, and the color deviation value of the adjacent larger viewing angle of −50° is 0.0091, and the difference in color deviation value is −0.0038. As the viewing angle shifts from −45° towards to −50°, the human eyes can perceive that the LCD screen adhering embodiment 7 undergoes a process of color deviation transformation. Similarly, as the right viewing angle is shifted from 45° towards to 50° (with the color deviation difference of −0.0019), the human eyes again observes the process of color deviation transformation on the LCD screen. The LCD display device adhering embodiment 8 has a maximum color deviation value at the left side viewing angle of −45° and the right side viewing angle of 45°, respectively. Wherein, the maximum color deviation value at the viewing angle of −45° is 0.0133, and the color deviation value of the adjacent larger viewing angle of −50° is 0.0102, and the difference in color deviation value is −0.0031. As the viewing angle shifts from −45° towards to −50°, the human eyes can observe a process of a transformation of color deviation value. Similarly, as the right viewing angle is shifted from 45° towards to 50° (with the color deviation difference of −0.0019), the human eyes again observes the process of color deviation transformation on the LCD screen. The LCD display device adhering embodiment 11 has three maximum values of color deviation at the left viewing angle of −40°, −50° and the right viewing angle of 45°. Wherein, the maximum color deviation value at the viewing angles of −40° and −50° are 0.0137 and 0.0131, and the color deviation value at the viewing angles of −45° and −55° are 0.0130 and 0.0091, and the difference in color deviation value are −0.0007 and −0.0040. As the viewing angle shifts from −40° towards to −55°, the human eyes can observe a process of color deviation transformation on the LCD screen adhering embodiment 11. As the right viewing angle shifts from 50° towards to 55°, the human eyes again observe the process of color deviation transformation on the LCD screen (with the color deviation difference of −0.0030). The LCD display device adhering embodiment 12 has three maximum values of color deviation at the left viewing angle of −40°, −50° and the right viewing angle of 45°. Wherein, the maximum color deviation values at the viewing angles of −40° and −50° are 0.0142 and 0.0139, while the color deviation value of the viewing angle of −45° and −55° are 0.0131 and 0.0105, and the difference in color deviation value is −0.0011 and −0.0034, respectively. As the viewing angle shifts from −40° towards to 55°, the human eyes can observe a color deviation transformation process on the LCD screen adhering embodiment 12. As the right viewing angle shifts from 50° towards to 55°, the human eyes again observe the process of color deviation transformation on the LCD screen (with a color deviation difference of −0.0027).

In comparison, the LCD display device adhering embodiment 9 also has a maximum color deviation value at −45° and 45°, wherein the maximum color deviation value at −45° is 0.0140, while the color deviation value at adjacent −50° viewing angle is 0.0122, and the difference in color deviation value is −0.0018. At this time, the difference in color deviation value is −0.0013 when the right side viewing angle shifts from 45° towards to 50°. Although the human eyes can still observe the transformation process of color deviation values upon the viewing angle shifts, the degree of abruptness is reduced, which to some extent enhances the subjective perception of viewing. The LCD display device adhering embodiment 10 also has a maximum color deviation value at −45° and 45°, wherein the maximum color deviation value at −45° is 0.0138, while the color deviation value at adjacent −50° viewing angle is 0.0129, and the difference in color deviation value is −0.0009. At this time, the difference in color deviation value is −0.0006 when the right side viewing angle shifts from 45° towards to 50°. The degree of abruptness is further reduced, which to some extent enhances the subjective perception of viewing when the transformation process of color deviation values occurs upon the viewing angle shifts. The LCD display device adhering embodiment 13 also has a maximum color deviation value at −50° and 45°, wherein the maximum color deviation value at −50° is 0.0151, while the color deviation value at adjacent −55° viewing angle is 0.0132, and the difference in color deviation value is −0.0019. At this time, the differences in color deviation value are −0.0001 and −0.0011 when the right side viewing angle shifts from 45° towards to 50° and shifts from 50° towards to 55 . . . . The degree of abruptness is slightly changed when the transformation process of color deviation values occurs upon the viewing angle shifts. The LCD display device adhering embodiment 14 also has a maximum color deviation value at −45° and 45°, wherein the maximum color deviation value at −45° is 0.0162, while the color deviation value at adjacent −50° viewing angle is 0.0152, and the difference in color deviation value is −0.0010. At this time, the difference in color deviation value is −0.0007 when the right side viewing angle shifts from 45° towards to 50°. The degree of abruptness is slightly changed when the transformation process of viewing angle occurs upon the viewing angle shifts.

Considering that the fluctuation of color deviation near the maximum value in the color deviation angle curve can easily cause abrupt changes of the LCD display device when the transformation process of color deviation values occurs upon the viewing angle shifts, affecting the subjective perception of viewing, the embodiments 9, 10, 13, and 14 are preferred where the changes of color deviation values near the maximum value are more than −0.0020 (greater than −0.0020 refers to the ranges between 0 to −0.0020).

TABLE 5
Test Data for color deviation viewing angle of the original LCD Display
device and adhering embodiments 7-14. and example 2

| | | Change value of | Maximum value of | Change value of |
|---|---|---|---|---|
| | Maximum value of | left color deviation | color deviation | right color deviation |
| | color deviation value | value (left viewing | value (right viewing | value (right viewing |
| tems | (left viewing angle) | angle) | angle | angle) |
| Embodiment7 | 0.0129 (−45°) | −0.0038 | 0.0127 (45°) | −0.0023 |
| Embodiment8 | 0.0133 (−45°) | −0.0031 | 0.0134 (45°) | −0.0019 |
| Embodiment9 | 0.0140 (−45°) | −0.0018 | 0.0139 (45°) | −0.0013 |
| Embodiment10 | 0.0138 (−45°) | −0.0009 | 0.0132 (45°) | −0.0006 |
| Embodiment11 | Maximum value 1 = 0.0137 | Maximum value 1 = 0.0007 | 0.0131 (50°) | −0.0030 |
| | (−40°) | Maximum value 2 = 0.0040 | | |
| | Maximum value 2 = 0.0131 | | | |
| | (−50°) | | | |
| Embodiment12 | Maximum value 1 = 0.0142 | Maximum value 1 = 0.0011 | 0.0137 (50°) | −0.0027 |
| | (−40°) | Maximum value 2 = 0.0034 | | |
| | Maximum value 2 = 0.0139 | | | |
| | (−50°) | | | |
| Embodiment13 | 0.0151 (−50°) | −0.0019 | 0.0142 (45°) | −0.0001 |
| Embodiment14 | 0.0162 (−45°) | −0.0010 | 0.0159 (45°) | −0.0007 |
| Example2 | 0.0171 (−45°) | −0.0013 | 0.0167 (45°) | −0.0028 |

Note: change value of left color deviation=Δu′v′_{-(|α|+5°)}-Δu′v′_{-(|α|)}, wherein a is the viewing angle corresponding to the maximum color deviation value in the left color deviation viewing angle curve; change value of left color deviation=Δu′v′_{(|β|+5°)}-Δu′v′_{-(|β|)}, Wherein, β is the viewing angle corresponding to the maximum color deviation value in the right color deviation viewing angle curve.

The above description is only the preferred embodiments of the present invention and is not intended to limit scope of protection of the present invention. All equal changes and modifications made based on content of the present invention are covered within scope of the patent of the present invention.

1. An optical functional thin film comprising:
a sequential arrangement of
a release layer,
a bonding layer,
a substrate layer,
an optical structure layer, and
a filling layer.

2. The optical functional thin film according to claim 1, wherein the optical structural layer refracts light and increases the viewing angle.

3. The optical functional thin film according to claim 1, wherein a surface of the filling layer has a fluctuating structure.

4. The optical functional thin film according to claim 1, wherein a refractive index N1 of the optical structure layer is greater than a refractive index N2 of the filling layer.

5. The optical functional film according to claim 1, wherein the substrate layer is selected from polyethylene terephthalate (PET), SRF, polycarbonate (PC), or triacetate fiber ester (TAC).

6. The optical functional thin film according to claim 1, wherein a surface joining the optical structure layer and the filling layer has of microstructures arranged at intervals in a first direction and infinitely extending the same in a second direction, and a cross-section of the microstructures is an isosceles trapezoidal structure.

7. The optical functional thin film according to claim 6, wherein in the optical structure layer, a first characteristic value t is a proportion of a width of an inclined edge of the isosceles trapezoid of the microstructures in a single cycle projecting onto a lower bottom to a single cycle, where t=2hcotθ/p, and t is between 23.61% and 28.74%.

8. The optical functional thin film according to claim 1, wherein a surface of the filling layer has a fluctuating structure, and a haze of the filling layer is 25%; a refractive index N1 of the optical structure layer is 1.62, and a refractive index N2 of the filling layer is between 1.43 and 1.50.

9. The optical functional thin film according to claim 6, wherein a length a of an upper bottom of the isosceles trapezoidal structure of the optical structural layer is 6 μm, a bottom angle is 79-°, and the period is 16.3 μm.

10. The optical functional thin film according to claim 1, wherein a refractive index N1 of the optical structure layer is 1.62, a refractive index N2 of the filling layer is 1.50, and a first characteristic value t is between one of 23.61% and 24.50%, and 27.45% and 27.59%.
